(19) United States
(12) Patent Application Publication
(10) Pub. No.: US 2026/0311175 A1
(43) Pub. Date: Oct. 8, 2026

(54) TRUSTED-ROOT IDENTIFIER-BASED MONETARY STATE OBJECT LIFECYCLE GOVERNANCE AND CROSS-SYSTEM VERIFICATION INFRASTRUCTURE

(71) Applicant: FURONG BEI, San Gabriel, CA (US)

(72) Inventor: FURONG BEI, San Gabriel, CA (US)

(21) Appl. No.: 19/722,780

(22) Filed: Jun. 27, 2026

Related U.S. Application Data
(63) Continuation-in-part of application No. 19/056,745, filed on Feb. 19, 2025.
(63) Continuation-in-part of application No. 19/058,739, filed on Feb. 20, 2025.
(63) Continuation-in-part of application No. 19/060,663, filed on Feb. 22, 2025.
(63) Continuation-in-part of application No. 19/064,689, filed on Feb. 27, 2025.
(63) Continuation-in-part of application No. 19/067,732, filed on Feb. 28, 2025.
(63) Continuation-in-part of application No. 19/067,845, filed on Mar. 1, 2025.
(63) Continuation-in-part of application No. 19/067,936, filed on Mar. 2, 2025, now abandoned.
(63) Continuation-in-part of application No. 19/069,285, filed on Mar. 4, 2025.
(63) Continuation-in-part of application No. 19/069,264, filed on Mar. 4, 2025.
(63) Continuation-in-part of application No. 19/069,257, filed on Mar. 4, 2025, now abandoned.
(63) Continuation-in-part of application No. 19/072,412, filed on Mar. 6, 2025.
(63) Continuation-in-part of application No. 19/072,075, filed on Mar. 6, 2025.
(63) Continuation-in-part of application No. 19/073,042, filed on Mar. 7, 2025, now abandoned.
(63) Continuation-in-part of application No. 19/074,355, filed on Mar. 8, 2025, now abandoned.
(63) Continuation-in-part of application No. 19/074,352, filed on Mar. 8, 2025.
(63) Continuation-in-part of application No. 19/076,910, filed on Mar. 11, 2025, now abandoned.
(63) Continuation-in-part of application No. 19/078,271, filed on Mar. 12, 2025, now abandoned.
(63) Continuation-in-part of application No. 19/079,378, filed on Mar. 13, 2025.
(63) Continuation-in-part of application No. 19/078,276, filed on Mar. 13, 2025.
(63) Continuation-in-part of application No. 19/080,825, filed on Mar. 15, 2025.
(63) Continuation-in-part of application No. 19/083,396, filed on Mar. 18, 2025.
(63) Continuation-in-part of application No. 19/083,371, filed on Mar. 18, 2025, now abandoned.
(63) Continuation-in-part of application No. 19/083,357, filed on Mar. 18, 2025.
(63) Continuation-in-part of application No. 19/083,345, filed on Mar. 18, 2025, now abandoned.
(63) Continuation-in-part of application No. 19/083,430, filed on Mar. 19, 2025.
(63) Continuation-in-part of application No. 19/084,806, filed on Mar. 20, 2025.
(63) Continuation-in-part of application No. 19/084,779, filed on Mar. 20, 2025.
(63) Continuation-in-part of application No. 19/084,753, filed on Mar. 20, 2025, now abandoned.
(63) Continuation-in-part of application No. 19/086,150, filed on Mar. 21, 2025.
(63) Continuation-in-part of application No. 19/087,483, filed on Mar. 22, 2025, now abandoned.
(63) Continuation-in-part of application No. 19/087,637, filed on Mar. 24, 2025, now abandoned.

(51) Int. Cl. G06Q 20/38; G06Q 20/40

(52) U.S. Cl. CPC G06Q 20/389; G06Q 20/401

(57) ABSTRACT

A trusted-root identifier-based monetary state object lifecycle governance and cross-system verification infrastructure is disclosed. A trusted-root identifier-based monetary authority registry binds issuer, governance, settlement, freeze, recovery, conversion, audit, and publication authorities to root identifiers, key histories, authority scopes, and rule versions. A rule-version engine validates issuance, transfer, settlement, freeze, revocation, recovery, conversion, audit, and publication predicates before a lifecycle transition is accepted. A machine-verifiable monetary state object stores a monetary object identifier, monetary class, issuer reference, owner or custody reference, authority reference, rule-version reference, lifecycle state, prior-state digest, event digest, ledger reference, policy container, privacy boundary, and receipt reference. A lifecycle ledger records append-only transition events. A monetary receipt generator outputs signed or otherwise verifiable monetary receipts for external banks, wallets, exchanges, auditors, regulators, clearing systems, and trusted-root or domain-rooted systems while preserving privacy boundaries.

### CROSS-REFERENCE TO RELATED APPLICATIONS

This application is drafted as a continuation-in-part style application directed to a trusted-root identifier-based monetary state governance layer within the BEI, ATMS, BEIMINT, TimeCurrency, BEI Currency, Trust Receipt, FR2 recovery, domain-rooted identity, policy-container, settlement, and cross-domain receipt technology families. Any domestic benefit, continuation, continuation-in-part, divisional, national-stage, foreign-priority, or other priority relationship is claimed only to the extent properly identified in an Application Data Sheet or other accepted filing record.

Related BEI and ATMS applications may disclose domain-rooted identifiers, signed endpoint records, decentralized identity anchors, BEIMINT or MF. app minting controls, TimeCurrency or BEI Currency value units, ATMS banking, clearing, settlement, reserve, exchange, FR2 rollback and correction, trust receipts, policy containers, domain parcels, namespace routing, behavioral evidence, and asset-package deployment. Such applications may be used as parent, companion, related, branch, implementation, or background support according to the official filing records and not merely by narrative statement.

A smaller, highly relevant ADS continuity set is preferred for formal domestic-benefit purposes. Broader portfolio applications may be referenced as ecosystem, implementation, or asset-package support without converting the claims of the present application into a claim to all BEI technologies.

The present application further specializes a broader domain-rooted universal object and receipt architecture by applying it to monetary state objects, monetary authority records, rule-version-pinned monetary lifecycle transitions, lifecycle ledgers, and monetary receipts. This specialization preserves the technical spine of the master architecture without expanding the present claims into non-monetary fields such as medical, education, family, general AI-agent governance, or general public-service management.

### FIELD

The field relates to computer-implemented monetary infrastructure, including trusted-root identifier-based monetary authority registries, machine-verifiable monetary state objects, rule-version engines, lifecycle state ledgers, monetary receipts, settlement-state verification, privacy-preserving audit routing, cross-system monetary verification, freeze, revocation, recovery, conversion, publication, and governance update operations.

### BACKGROUND

Modern monetary systems are fragmented across commercial-bank ledgers, payment processors, wallet systems, stable-value instruments, tokenized-deposit platforms, central-bank digital currency gateways, exchange custody systems, enterprise treasury systems, government benefit ledgers, and emerging time-currency or behavior-currency systems.

A conventional account balance or token balance may show an amount, but usually does not expose a portable, machine-verifiable answer to who authorized the monetary unit, which rule version governed issuance, whether a freeze or revocation exists, whether a settlement is final, whether a recovery or replacement occurred, and which external verifier may rely on the state.

Blockchain tokens provide transfer history in a particular ledger, but they often do not provide a domain-rooted authority registry, jurisdictionally versioned policy container, non-destructive freeze, recovery, replacement, or selective disclosure audit path that external banking and regulatory systems can verify without taking over ledger custody.

Traditional bank records provide institution-level controls, but those controls are generally not portable across heterogeneous wallets, exchanges, enterprise ledgers, stable-value systems, tokenized-deposit systems, time-currency systems, and behavior-economic value systems.

Central-bank money, commercial-bank deposits, tokenized deposits, verified deposits, digital currencies, stable-value instruments, reward units, time-denominated units, and behavior-economy units all need a common verification structure that separates legal or policy authority from a concrete technical state machine.

A need exists for an infrastructure that converts a monetary unit, batch, deposit representation, value interval, or currency-like unit into a machine-verifiable monetary state object that carries references to authority, rule version, lifecycle state, prior state, event digest, policy container, privacy boundary, and receipt material.

A further need exists for a monetary receipt that can be returned to an external bank, wallet, exchange, clearing system, auditor, regulator, merchant, enterprise system, or domain-rooted application as a concise verification artifact without disclosing underlying private data beyond a policy-authorized boundary.

The disclosed system addresses these needs with a focused monetary state governance layer. It does not claim sovereign power to issue legal tender, determine monetary policy, replace central-bank authority, or compel institutional adoption. Instead, it provides a computer architecture for verifiable monetary state representation, lifecycle control, and receipt generation.

### SUMMARY

Disclosed is a trusted-root identifier-based monetary state object lifecycle governance and cross-system verification infrastructure configured to create, verify, update, freeze, revoke, recover, convert, settle, archive, publish, and externally verify machine-verifiable monetary state objects.

A trusted-root identifier-based monetary authority registry binds root monetary identifiers to issuer authority, governance authority, settlement authority, freeze authority, recovery authority, conversion authority, audit authority, publication authority, key history, rule-version scope, and validity interval records.

A rule-version engine evaluates lifecycle predicates before any monetary state transition is accepted. The evaluated predicates may include issuer authority, prior-state digest continuity, monetary class, source-state validity, reserve or provenance reference, ledger-state status, privacy boundary, jurisdictional policy, time window, external verifier role, and permitted next state.

An issuance and lifecycle controller creates or updates a machine-verifiable monetary state object. The object may include a monetary object identifier, monetary class, issuer reference, owner or custody reference, authority reference, rule-version reference, monetary amount or unit reference, reserve or provenance reference, lifecycle state, prior-state digest, event digest, ledger reference, policy-container reference, privacy-boundary reference, receipt reference, and permitted next-state list.

A lifecycle ledger records append-only events corresponding to issued, active, pending, settled, held, frozen, revoked, recovered, converted, expired, archived, published, or reviewed states. A lifecycle event may be rejected if a state transition is not permitted by the pinned rule version.

A monetary receipt generator creates issuance, activation, transfer, settlement, hold, freeze, revocation, recovery, conversion, audit, publication, reserve, governance-update, and external-verification receipts. The receipt binds the monetary state object, prior-state digest, event digest, rule version, lifecycle result, authority record, and verification material.

A privacy-preserving audit router may publish only selected digest and receipt fields while withholding financial account data, personally identifiable information, protected data, or confidential institutional information unless an applicable policy container authorizes disclosure.

The system may be used as a specialized monetary-state layer of a broader domain-rooted universal object and receipt architecture. In that broader architecture, identity, authority, time, policy, privacy, evidence, signature, receipt, and synchronization fields support cross-sector use; in the present application, those fields are specialized to monetary lifecycle governance.

### BRIEF DESCRIPTION OF THE DRAWINGS

FIG. 1 illustrates an overall trusted-root identifier-based monetary state object lifecycle governance and cross-system verification infrastructure.

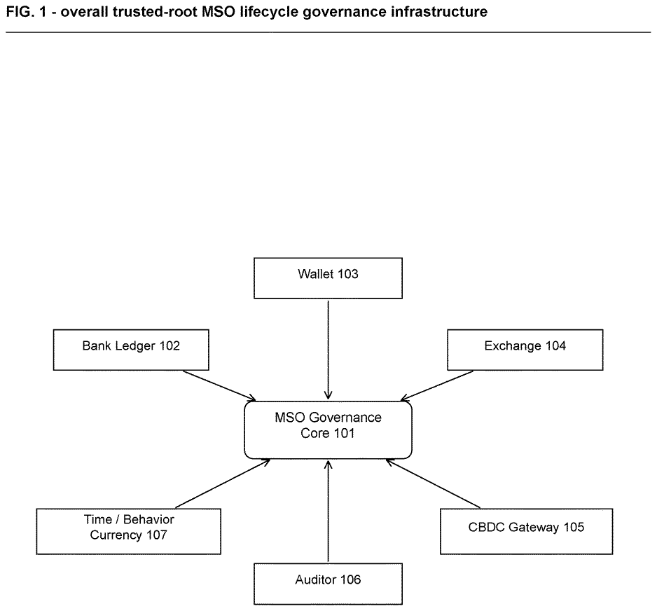

FIG. 2 illustrates a layered monetary state governance stack including external monetary systems, a trusted-root authority registry, a rule-version and policy-container engine, monetary state object normalization, a lifecycle ledger, a receipt verification API, and audit, recovery, and publication layers.

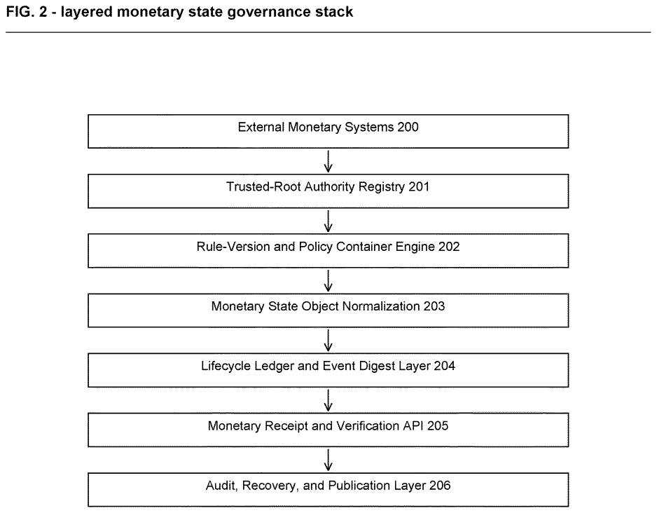

FIG. 3 illustrates a trusted-root authority registry and key-history mapping structure.

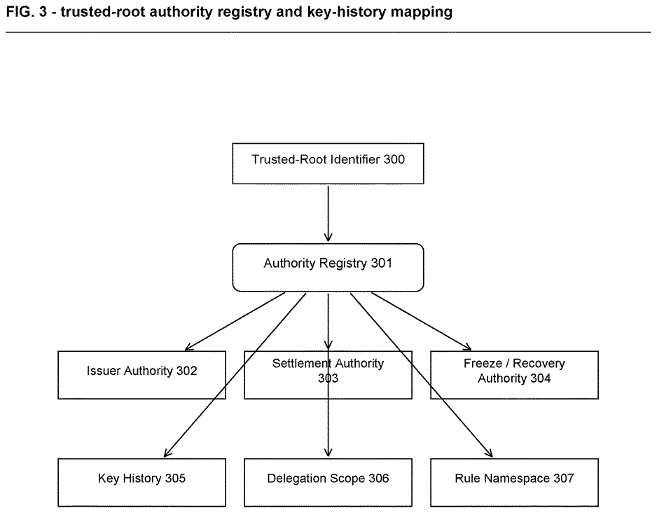

FIG. 4 illustrates a machine-verifiable monetary state object data structure.

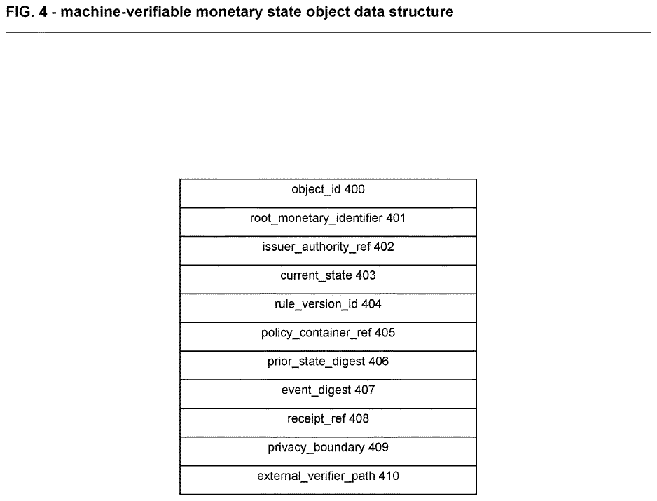

FIG. 5 illustrates an issuance and rule-version validation pipeline for creating a monetary state object and generating a receipt.

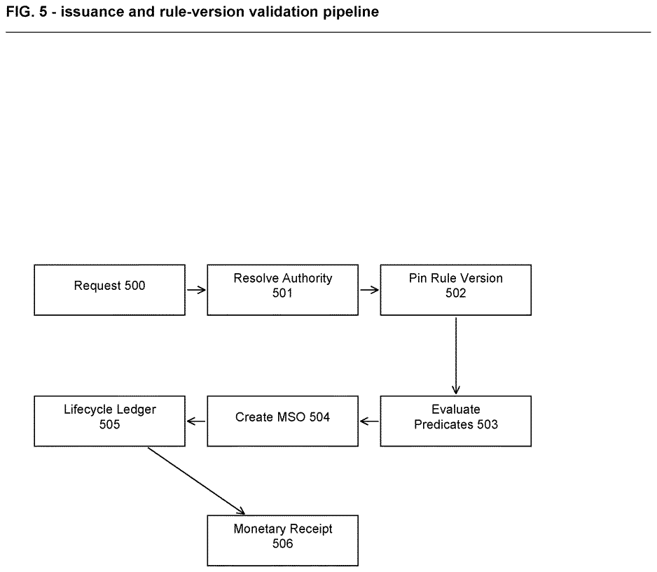

FIG. 6 illustrates a monetary lifecycle state machine.

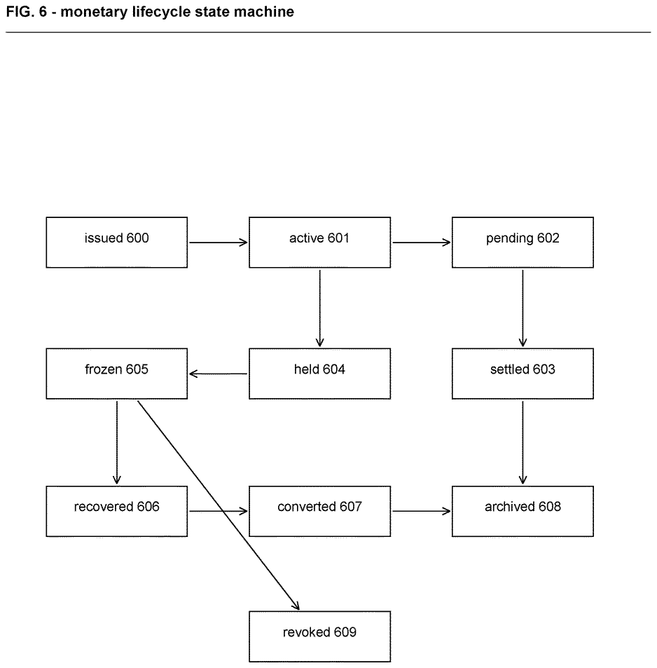

FIG. 7 illustrates append-only lifecycle ledger events with prior-state digest chaining.

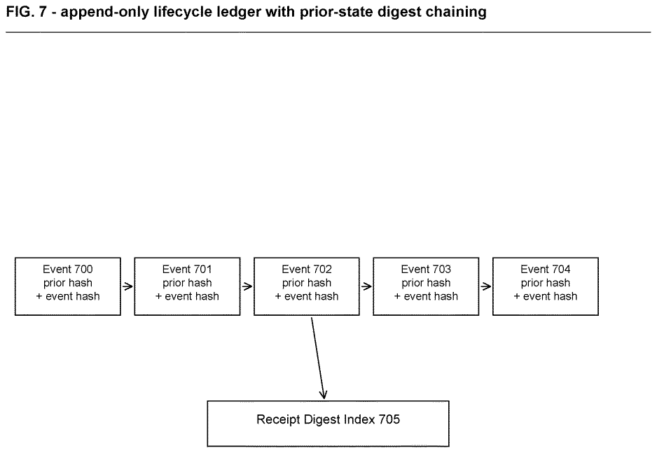

FIG. 8 illustrates monetary receipt generation and external verification.

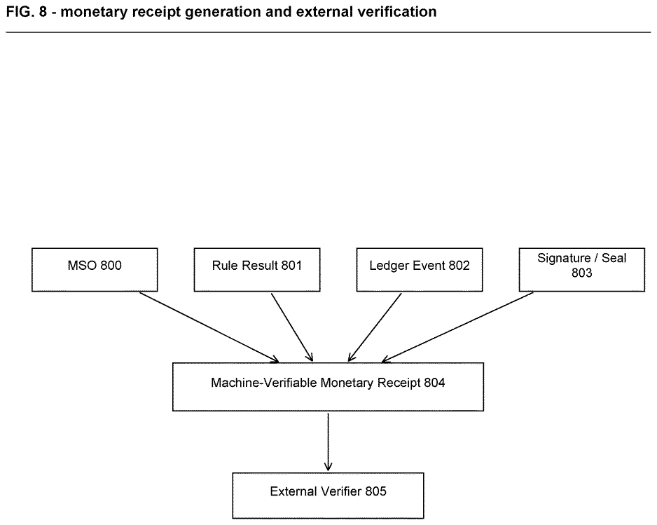

FIG. 9 illustrates a non-destructive freeze, revocation, and recovery path.

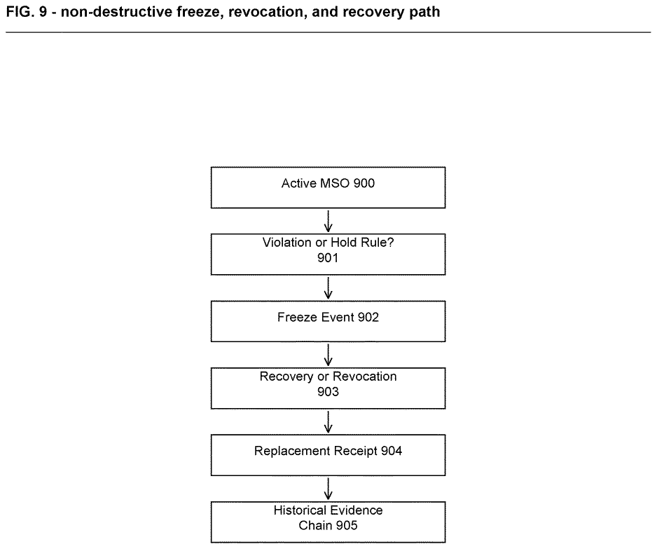

FIG. 10 illustrates cross-system normalized monetary state mapping.

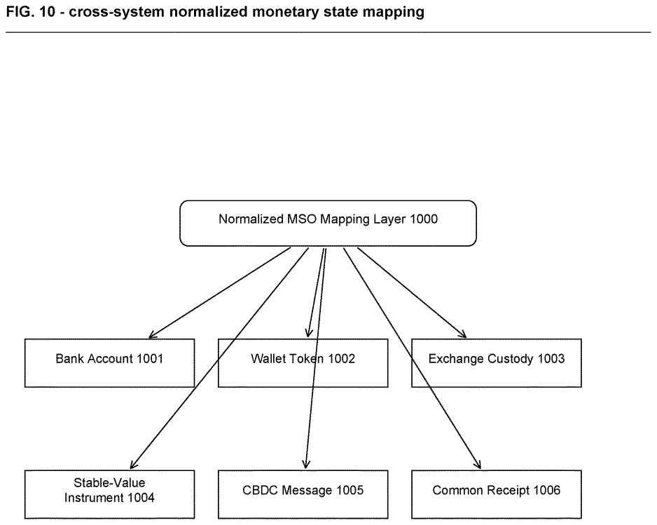

FIG. 11 illustrates privacy-boundary audit and selective disclosure routing.

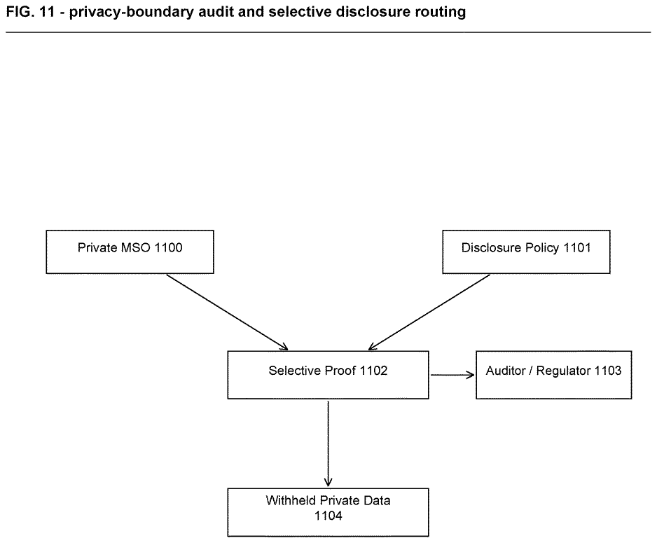

FIG. 12 illustrates governance update and rule-version history.

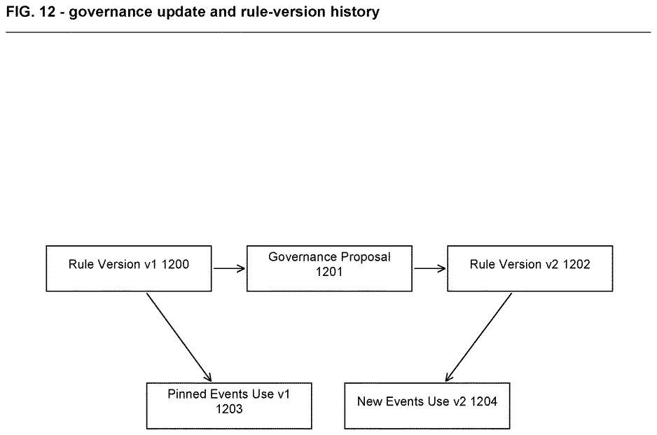

FIG. 13 illustrates a policy-container decision tree for a monetary state transition.

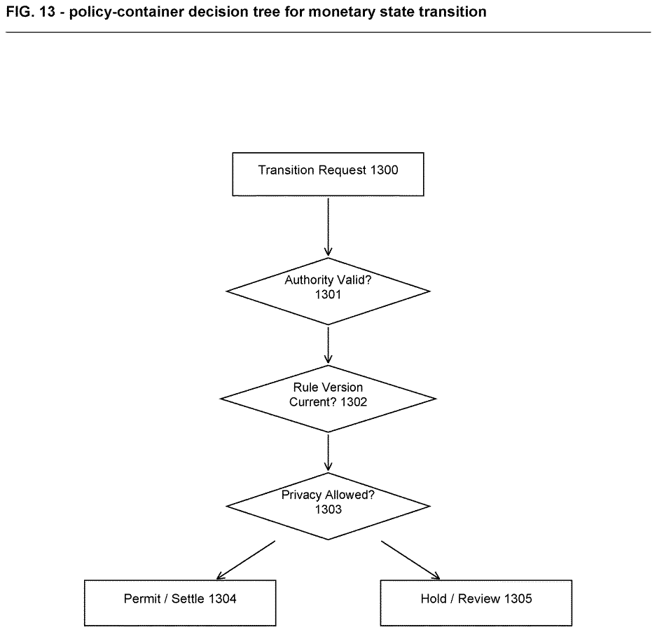

FIG. 14 illustrates a verification API request and response schema.

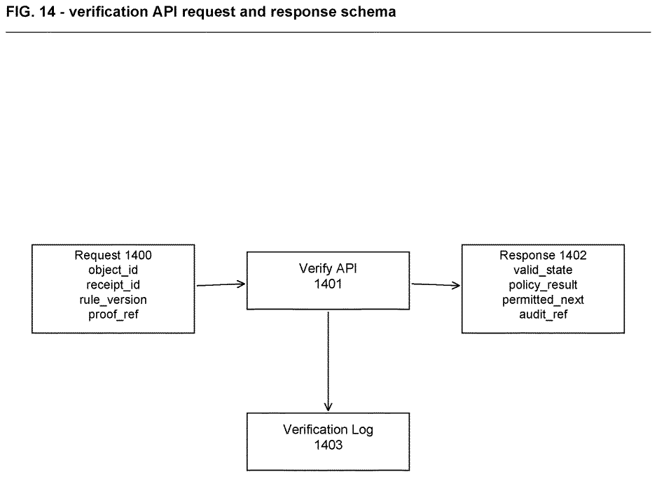

FIG. 15 illustrates continuation-in-part support from a universal object and receipt architecture.

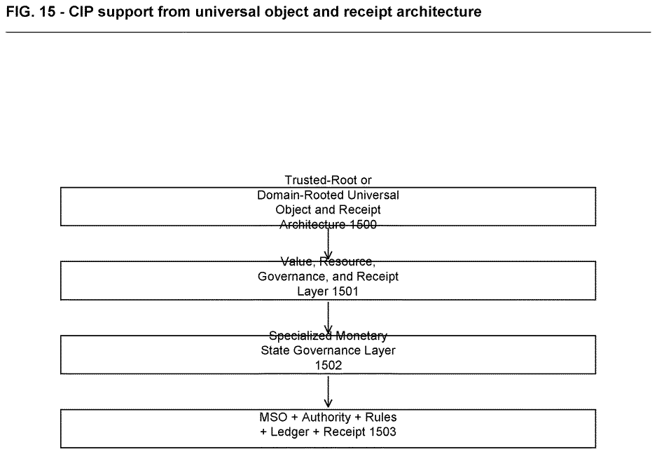

FIG. 16 illustrates a Monetary Object, Monetary State Object, and Monetary Receipt product-layer hierarchy.

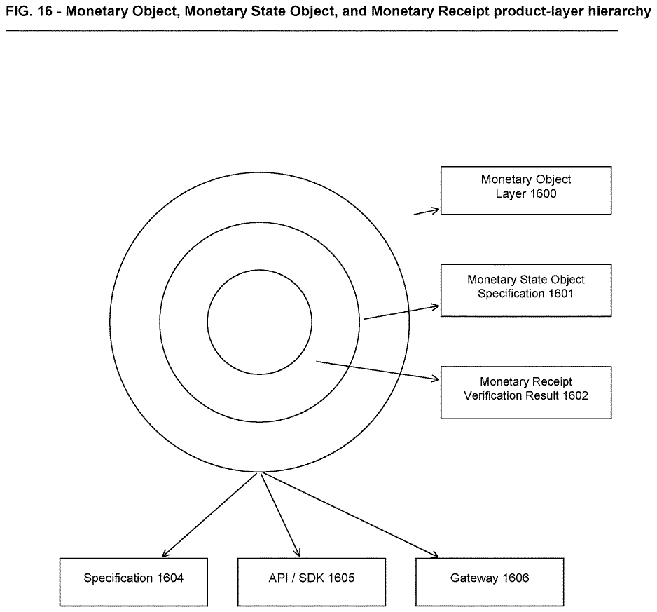

FIG. 17 illustrates a banking, exchange, and settlement deployment scenario.

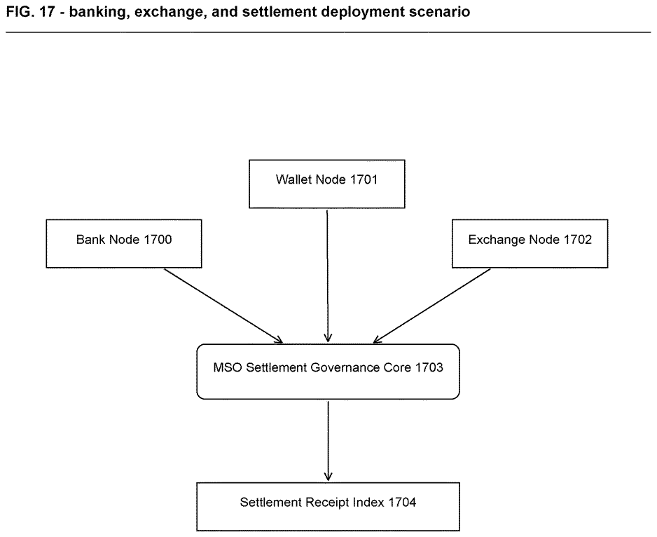

FIG. 18 illustrates time-currency and behavior-currency integration with a monetary state object.

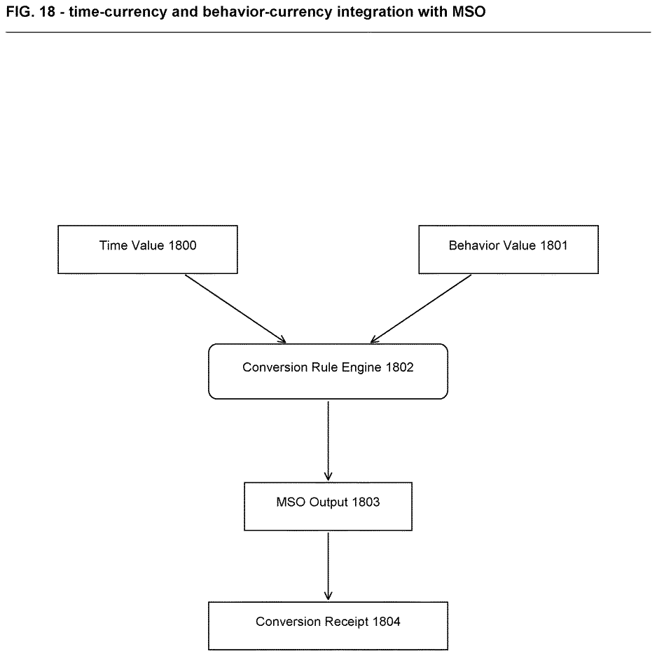

FIG. 19 illustrates a failure detection, recovery, and audit closed loop.

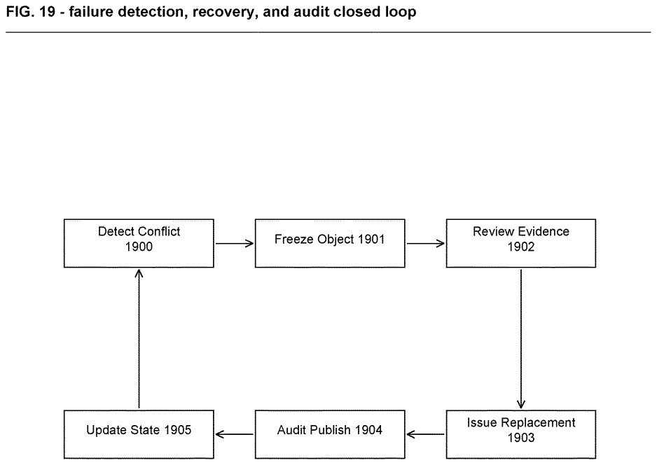

FIG. 20 illustrates an API and SDK deployment including SovMonetary, MonetaryObject, MonetaryStateObject, MonetaryReceipt, BEIIdentifier, and BEIMSO endpoints as non-limiting examples.

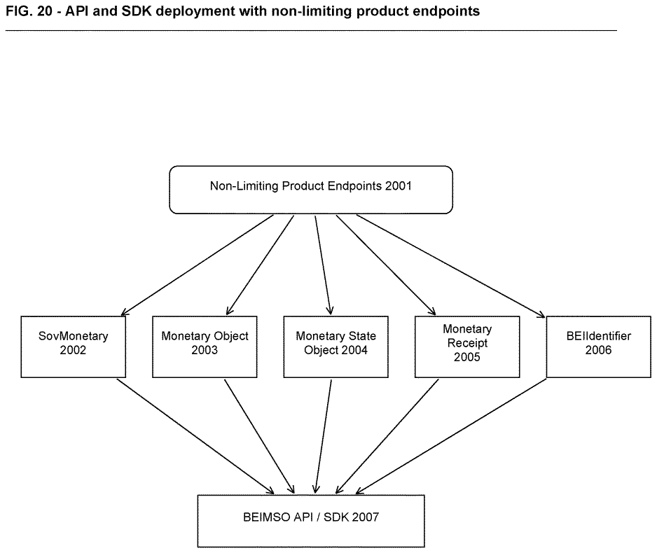

FIG. 21 illustrates an end-to-end processing sequence.

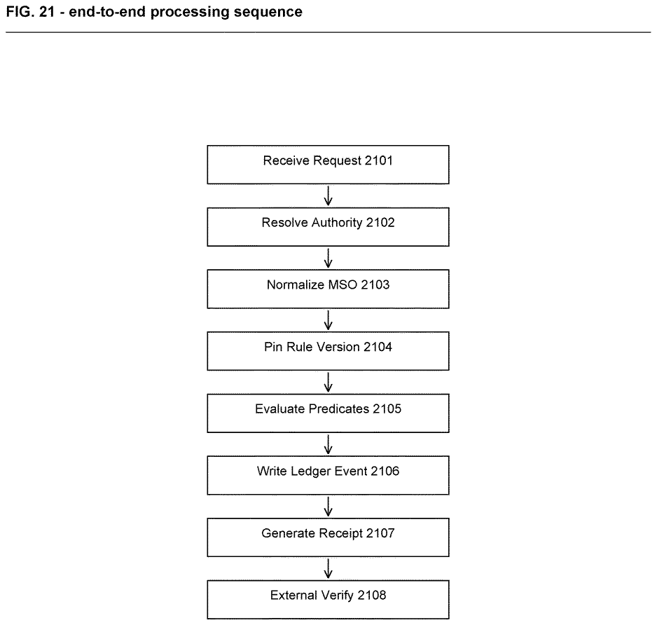

### DETAILED DESCRIPTION

The following description provides technical embodiments and examples. The embodiments are illustrative and not limiting. Terms such as registry, engine, controller, ledger, object, receipt, router, bus, endpoint, state machine, and service may be implemented in software, firmware, hardware, secure enclaves, cloud services, distributed ledgers, institutional databases, message queues, application programming interfaces, or hybrid combinations thereof.

The expressions SovMonetary, SovereignMonetary, BEIIdentifier, BEIMSO, Monetary Object, Monetary State Object, Monetary Receipt, Trust Receipt, ATMS, BEIMINT, BEI Currency, TimeCurrency, FR2, and Policy Container may be used as ecosystem, product, domain-name, service, protocol, interface, or implementation names. They do not limit the invention to any particular web site, registrar, trademark, server, company, chain, database, currency, financial rail, or commercial deployment.

As used herein, a “trusted-root identifier” or “root identifier” refers to a resolvable authority anchor configured to bind an authority record, rule-version reference, verification endpoint, key-history record, governance scope, policy container, or lifecycle control information. The trusted-root identifier may include, without limitation, a domain name, subdomain, DNS-linked identifier, decentralized identifier, uniform resource identifier, certificate namespace, public-key namespace, institutional registry identifier, legal-entity identifier, government registry identifier, blockchain namespace, enterprise namespace, account-root identifier, signed endpoint record, hybrid namespace, or another resolvable authority-root identifier. A domain-rooted implementation is a preferred embodiment unless expressly required by a claim.

### Trusted-Root Monetary Authority Registry

The trusted-root identifier-based monetary authority registry stores authority records that are resolvable from a controlled domain-rooted identifier, institutional namespace, decentralized identifier, signed endpoint record, or hybrid naming root.

An authority record may identify an issuer, governance committee, settlement operator, reserve custodian, freeze authority, recovery authority, conversion authority, auditor, regulator, publication service, or external-verifier role.

Each authority record may include a validity interval, credential reference, public key or key history, delegation scope, revocation status, rule-version scope, jurisdictional applicability, and permitted action class.

The registry may be centralized within a regulated institution, federated among participating institutions, implemented on a distributed ledger, implemented through signed records, or implemented in a hybrid architecture.

### Machine-Verifiable Monetary State Object

The monetary state object is a machine-readable record representing a monetary unit, batch, value interval, deposit representation, wallet representation, settlement claim, time-currency unit, behavior-currency unit, verified deposit, tokenized deposit, stable-value instrument, or other currency-like value unit.

The object is not merely a balance entry. It carries lifecycle state, authority lineage, rule-version lineage, prior-state digest, event digest, receipt reference, policy-container reference, privacy-boundary reference, ledger reference, and permitted next-state list.

The object may be portable or externally verifiable without requiring every receiving system to replicate or control the originating ledger.

In some embodiments, the object is a specialized instance of a broader universal object model that also supports identity, trust, time, resource, AI-agent, family, medical, educational, government, and industry objects. In the present monetary layer, the universal fields are narrowed to monetary-state governance.

### Rule-Version Engine

The rule-version engine pins each lifecycle request to a particular rule-version identifier. Pinning prevents a transition from being verified under a policy version that did not govern the event.

A rule version may include issuance caps, reserve predicates, redemption predicates, ownership or custody constraints, transfer conditions, freeze predicates, recovery predicates, conversion formulas, settlement-finality rules, publication permissions, external-verifier roles, and privacy-boundary rules.

The rule-version engine rejects stale, unapproved, revoked, mismatched, jurisdictionally invalid, or superseded rule versions.

The rule-version engine may return permit, block, hold, restrict, freeze, settle, revoke, recover, convert, archive, publish, manual-review, or conflict states.

### Lifecycle Ledger

The lifecycle ledger records append-only monetary transition events. Each event may include the object identifier, prior-state digest, current-state digest, event digest, rule-version identifier, authority-record identifier, timestamp or interval reference, policy result, privacy-boundary result, and receipt identifier.

The ledger may be an institutional ledger, a dedicated lifecycle ledger, a ledger overlay, a distributed ledger, a database with hash chaining, a secure log, or a hybrid audit structure.

A receiving system may verify a receipt and state without assuming custody of the underlying ledger or viewing private account records.

If a rollback, replay, duplicate interval, stale proof, or invalid prior-state digest is detected, the lifecycle ledger may reject the event or place the object into a held or review state.

### Monetary Receipt Generator

The monetary receipt generator produces machine-verifiable receipts corresponding to monetary lifecycle events. A receipt may be signed, sealed, hash-bound, credential-bound, or otherwise verifiable by an external verifier.

A receipt may include root monetary identifier, monetary object identifier, lifecycle state, rule-version identifier, authority record, prior-state digest, event digest, policy result, privacy-boundary status, ledger reference, timestamp or interval, and verification material.

Receipt types include issuance, activation, transfer, settlement, hold, freeze, revocation, recovery, conversion, audit, publication, reserve, governance-update, and external-verification receipts.

The receipt is the principal external evidence output of the infrastructure. It enables banks, wallets, exchanges, auditors, regulators, merchants, enterprise systems, and domain-rooted applications to verify monetary state without requiring the same internal database.

### Privacy-Preserving Audit Router

The privacy-preserving audit router separates proof of state from disclosure of underlying private records. It may publish digest-only receipts, selective-disclosure proofs, encrypted references, zero-knowledge proofs, credential proofs, or role-gated responses.

Financial account information, personally identifiable information, protected health information, institutional secrets, trade secrets, reserve-location details, and confidential customer records may remain inside an originating domain unless a policy container permits disclosure.

This privacy boundary improves regulatory and institutional adoption because a verifier can confirm state while the originator retains data custody.

The router may provide different views for public verifiers, counterparties, auditors, regulators, courts, administrators, and internal risk systems.

### Freeze, Revocation, Recovery, and Replacement

A freeze controller may transition the object to held or frozen status without deleting its prior lifecycle chain. A freeze receipt may record authority, reason code, time interval, affected scope, and review path.

A revocation controller may transition the object to revoked status and generate a revocation receipt that prevents reuse of the revoked object while preserving evidence.

A recovery controller may create a replacement object linked to the source object by recovery receipt and replacement receipt, thereby preserving prior evidence while permitting controlled correction.

This approach differs from destructive deletion or undocumented correction because the prior state remains audit-visible according to policy.

### Conversion Layer

A conversion controller may convert a monetary state object between fiat-linked representation, commercial-bank deposit representation, tokenized deposit, verified deposit, stable-value instrument, CBDC gateway representation, time-currency unit, behavior-currency unit, enterprise credit, marketplace credit, or governmental benefit unit.

The conversion controller applies rule-versioned conversion formulas and records both source and destination object references.

A conversion receipt binds source state, destination state, conversion rule version, amount or unit mapping, fee or spread basis where applicable, authority record, and event digest.

The conversion layer supports cross-system interoperability without treating all monetary classes as identical or ignoring jurisdictional policy.

### External Verification API

The external verification API receives a receipt identifier, object identifier, event digest, or root monetary identifier and returns a verification response.

The response may include lifecycle state, authority status, rule-version status, prior-state digest status, event-digest status, policy result, privacy-boundary status, ledger-state status, and permitted next state.

The response may be implemented as an API, SDK, wallet endpoint, bank middleware endpoint, exchange endpoint, regulator portal, auditor interface, command-line tool, browser interface, or service bus message.

Non-limiting product endpoints may include SovMonetary for institutional monetary infrastructure, MonetaryObject for object-level specifications, MonetaryStateObject for MSO developer documentation, MonetaryReceipt for receipt verification, and BEIMSO for BEI/ATMS implementation services.

### MONETARY STATE OBJECT DATA STRUCTURE

The monetary state object may include field 1: mso_id. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 2: root_monetary_identifier. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 3: domain_root. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 4: monetary_class. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 5: issuer_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 6: owner_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 7: custody_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 8: authority_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 9: rule_version_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 10: policy_container_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 11: jurisdiction_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 12: privacy_boundary_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 13: amount_or_unit_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 14: reserve_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 15: provenance_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 16: source_system_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 17: destination_system_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 18: lifecycle_state. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 19: prior_state_digest. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 20: current_state_digest. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 21: event_digest. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 22: ledger_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 23: receipt_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 24: external_verifier_scope. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 25: permitted_next_states. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 26: recovery_state. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 27: publication_state. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 28: sync_state. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 29: key_history_ref. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 30: signature_state. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

The monetary state object may include field 31: audit_scope. The field is processed by the lifecycle controller and rule-version engine and is not merely descriptive metadata when used to determine whether a requested lifecycle transition is permitted, blocked, held, frozen, revoked, recovered, converted, archived, published, or sent to manual review.

### LIFECYCLE STATE MACHINE

In the created state, the infrastructure stores a state timestamp or interval, initiating actor or authority, prior-state digest, event digest, applicable rule version, policy result, privacy-boundary result, receipt reference, and permitted next-state list. A transition out of created is permitted only when the pinned rule version and authority record authorize the requested transition.

In the issued state, the infrastructure stores a state timestamp or interval, initiating actor or authority, prior-state digest, event digest, applicable rule version, policy result, privacy-boundary result, receipt reference, and permitted next-state list. A transition out of issued is permitted only when the pinned rule version and authority record authorize the requested transition.

In the active state, the infrastructure stores a state timestamp or interval, initiating actor or authority, prior-state digest, event digest, applicable rule version, policy result, privacy-boundary result, receipt reference, and permitted next-state list. A transition out of active is permitted only when the pinned rule version and authority record authorize the requested transition.

In the pending state, the infrastructure stores a state timestamp or interval, initiating actor or authority, prior-state digest, event digest, applicable rule version, policy result, privacy-boundary result, receipt reference, and permitted next-state list. A transition out of pending is permitted only when the pinned rule version and authority record authorize the requested transition.

In the settled state, the infrastructure stores a state timestamp or interval, initiating actor or authority, prior-state digest, event digest, applicable rule version, policy result, privacy-boundary result, receipt reference, and permitted next-state list. A transition out of settled is permitted only when the pinned rule version and authority record authorize the requested transition.

In the held state, the infrastructure stores a state timestamp or interval, initiating actor or authority, prior-state digest, event digest, applicable rule version, policy result, privacy-boundary result, receipt reference, and permitted next-state list. A transition out of held is permitted only when the pinned rule version and authority record authorize the requested transition.

In the frozen state, the infrastructure stores a state timestamp or interval, initiating actor or authority, prior-state digest, event digest, applicable rule version, policy result, privacy-boundary result, receipt reference, and permitted next-state list. A transition out of frozen is permitted only when the pinned rule version and authority record authorize the requested transition.

In the under-review state, the infrastructure stores a state timestamp or interval, initiating actor or authority, prior-state digest, event digest, applicable rule version, policy result, privacy-boundary result, receipt reference, and permitted next-state list. A transition out of under-review is permitted only when the pinned rule version and authority record authorize the requested transition.

In the revoked state, the infrastructure stores a state timestamp or interval, initiating actor or authority, prior-state digest, event digest, applicable rule version, policy result, privacy-boundary result, receipt reference, and permitted next-state list. A transition out of revoked is permitted only when the pinned rule version and authority record authorize the requested transition.

In the recovered state, the infrastructure stores a state timestamp or interval, initiating actor or authority, prior-state digest, event digest, applicable rule version, policy result, privacy-boundary result, receipt reference, and permitted next-state list. A transition out of recovered is permitted only when the pinned rule version and authority record authorize the requested transition.

In the converted state, the infrastructure stores a state timestamp or interval, initiating actor or authority, prior-state digest, event digest, applicable rule version, policy result, privacy-boundary result, receipt reference, and permitted next-state list. A transition out of converted is permitted only when the pinned rule version and authority record authorize the requested transition.

In the expired state, the infrastructure stores a state timestamp or interval, initiating actor or authority, prior-state digest, event digest, applicable rule version, policy result, privacy-boundary result, receipt reference, and permitted next-state list. A transition out of expired is permitted only when the pinned rule version and authority record authorize the requested transition.

In the archived state, the infrastructure stores a state timestamp or interval, initiating actor or authority, prior-state digest, event digest, applicable rule version, policy result, privacy-boundary result, receipt reference, and permitted next-state list. A transition out of archived is permitted only when the pinned rule version and authority record authorize the requested transition.

In the published state, the infrastructure stores a state timestamp or interval, initiating actor or authority, prior-state digest, event digest, applicable rule version, policy result, privacy-boundary result, receipt reference, and permitted next-state list. A transition out of published is permitted only when the pinned rule version and authority record authorize the requested transition.

A permitted transition table may authorize created to issued, issued to active, active to pending, pending to settled, active or pending to held, held to active or frozen, frozen to recovered or revoked, revoked to archived or recovered-by-replacement, recovered to active or archived, converted to active or archived, expired to archived or reissued-by-new-object, and any state to manual review according to policy. Unsupported transitions are rejected or held for review.

The state machine is intentionally precise. It avoids unrestricted transitions such as revoked directly to issued unless a separate replacement monetary state object is created and linked through a recovery receipt.

### REPRESENTATIVE ALGORITHMS

Algorithm ResolveAuthority: receive root monetary identifier; resolve authority registry record; validate key history; validate authority scope; validate validity interval; return authority status and rule-version scope.

Algorithm ResolveAuthority may be implemented by executable instructions stored on one or more non-transitory computer-readable media and executed by one or more processors coupled to memory, network interfaces, cryptographic modules, registries, ledgers, queues, and data stores.

Algorithm CreateMSO: receive issuance request; normalize monetary class and issuer reference; compute object identifier; bind rule-version identifier; compute initial event digest; write issued state; generate issuance receipt.

Algorithm CreateMSO may be implemented by executable instructions stored on one or more non-transitory computer-readable media and executed by one or more processors coupled to memory, network interfaces, cryptographic modules, registries, ledgers, queues, and data stores.

Algorithm EvaluateTransition: read current lifecycle state; read permitted next-state list; load pinned rule version; evaluate authority, policy, time, privacy, ledger, prior-state digest, and external verifier status; return lifecycle result.

Algorithm EvaluateTransition may be implemented by executable instructions stored on one or more non-transitory computer-readable media and executed by one or more processors coupled to memory, network interfaces, cryptographic modules, registries, ledgers, queues, and data stores.

Algorithm GenerateMonetaryReceipt: collect root identifier, object identifier, rule version, authority record, prior-state digest, event digest, lifecycle result, timestamp or interval, privacy boundary, and policy result; compute receipt digest; sign or seal receipt; store receipt reference.

Algorithm GenerateMonetaryReceipt may be implemented by executable instructions stored on one or more non-transitory computer-readable media and executed by one or more processors coupled to memory, network interfaces, cryptographic modules, registries, ledgers, queues, and data stores.

Algorithm FreezeOrHold: receive freeze or hold request; validate freeze authority; identify affected monetary scope; preserve prior chain; write held or frozen transition; generate freeze receipt; expose review path.

Algorithm FreezeOrHold may be implemented by executable instructions stored on one or more non-transitory computer-readable media and executed by one or more processors coupled to memory, network interfaces, cryptographic modules, registries, ledgers, queues, and data stores.

Algorithm RevokeAndRecover: receive revocation or recovery request; validate revocation or recovery authority; place source object in revoked or frozen state; generate source receipt; create replacement object if authorized; link replacement receipt to source receipt.

Algorithm RevokeAndRecover may be implemented by executable instructions stored on one or more non-transitory computer-readable media and executed by one or more processors coupled to memory, network interfaces, cryptographic modules, registries, ledgers, queues, and data stores.

Algorithm ConvertMSO: receive conversion request; validate source object state; validate destination monetary class; load conversion rule version; compute destination value or unit reference; write source and destination events; generate conversion receipt.

Algorithm ConvertMSO may be implemented by executable instructions stored on one or more non-transitory computer-readable media and executed by one or more processors coupled to memory, network interfaces, cryptographic modules, registries, ledgers, queues, and data stores.

Algorithm VerifyReceipt: receive verification request; authenticate verifier role when required; fetch receipt reference; validate signature or proof material; validate prior-state digest and event digest; apply privacy policy; return verification response.

Algorithm VerifyReceipt may be implemented by executable instructions stored on one or more non-transitory computer-readable media and executed by one or more processors coupled to memory, network interfaces, cryptographic modules, registries, ledgers, queues, and data stores.

### REPRESENTATIVE EMBODIMENTS

### Commercial-Bank Deposit State Governance

In a Commercial-Bank Deposit State Governance embodiment, a bank converts an internal deposit or verified deposit into a monetary state object, binds it to bank authority records, and exposes a receipt to external verifiers without revealing full account history.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Tokenized-Deposit Pre-clearing

In a Tokenized-Deposit Pre-Clearing embodiment, a tokenized-deposit platform validates issuer authority, reserve reference, rule version, ledger state, and settlement-finality condition before release or transfer.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Stable-Value Instrument Audit

In a Stable-Value Instrument Audit embodiment, a stable-value issuer publishes reserve and lifecycle receipts that auditors can verify through digest and authority records while reserve details remain policy-bound.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### CBDC Gateway Interoperability

In a CBDC Gateway Interoperability embodiment, a central-bank gateway or authorized service provider maps a CBDC state reference to a monetary state object for external verification and cross-system settlement messaging.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Exchange Custody and Settlement

In an Exchange Custody and Settlement embodiment, an exchange verifies deposit state, freeze status, rule version, custody authority, and withdrawal eligibility before settlement or listing.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Wallet Verification

In a Wallet Verification embodiment, a digital wallet queries a verification endpoint to determine whether a monetary object is active, frozen, revoked, recovered, converted, or settled before allowing downstream action.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Timecurrency and Behavior-Currency Integration

In a TimeCurrency and Behavior-Currency Integration embodiment, a time-denominated or behavior-economic value unit is represented as a monetary state object after policy-controlled minting and is verified through a monetary receipt.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Government Benefit Disbursement

In a Government Benefit Disbursement embodiment, a government benefit system binds a benefit unit to eligibility authority, budget reference, recipient identity status, rule version, and receipt chain before disbursement.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Enterprise Treasury

In an Enterprise Treasury embodiment, an enterprise treasury system verifies intercompany credit, purchase obligation, settlement state, policy approval, and audit receipt before release of value.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Cross-Border Settlement

In a Cross-Border Settlement embodiment, a cross-border payment or clearing system maps source, destination, currency class, jurisdiction, sanctions policy, finality rule, and receipt status before settlement.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Recovery After Error or Fraud

In a Recovery After Error or Fraud embodiment, a system freezes an affected monetary state object, issues a revocation or recovery receipt, creates a replacement object if authorized, and preserves the prior evidence chain.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### Public Standard and Product Deployment

In a Public Standard and Product Deployment embodiment, a specification, SDK, API, or verification gateway may be deployed through domain-rooted endpoints such as SovMonetary, MonetaryObject, MonetaryStateObject, MonetaryReceipt, BEIIdentifier, BEIMSO, TrustReceipt, PolicyContainer, ATMS, BEIMINT, BEI Currency, or TimeCurrency as non-limiting implementation names.

The embodiment uses the same five-part monetary governance core: monetary authority registry, machine-verifiable monetary state object, rule-version engine, lifecycle ledger, and monetary receipt. Sector-specific fields may be added through policy containers without altering the core lifecycle verification model.

The technical advantage is improved external verification, reduced reconciliation ambiguity, audit-preserving correction, privacy-boundary preservation, and deterministic lifecycle-state control across heterogeneous monetary systems.

### CIP SUPPORT AND MASTERROOT INTEGRATION

The present monetary application may be supported by a master domain-rooted universal object and receipt architecture in which heterogeneous human, family, organizational, governmental, industry, asset, resource, currency, service, device, and AI-agent objects are normalized into root objects with identity, authority, time, value or resource, policy, jurisdiction, privacy, evidence, signature, receipt, and synchronization fields.

The monetary state object disclosed here is a specialized monetary instance of that universal architecture. The broader architecture provides background support for field structures and receipt semantics; the present claims remain focused on monetary state governance.

The governance engine of the broader architecture evaluates policy, jurisdiction, privacy, authority, and time conditions before a downstream state transition. The present monetary rule-version engine narrows that concept into rule-version-pinned monetary lifecycle predicates.

The receipt engine of the broader architecture generates machine-verifiable receipts. The present monetary receipt generator narrows that concept into monetary receipts for issuance, activation, transfer, settlement, hold, freeze, revocation, recovery, conversion, audit, publication, and external verification.

The synchronization bus of the broader architecture supports digest and receipt sharing across domain-rooted systems. The present monetary infrastructure uses that concept for monetary receipt digest publication, external verification, and privacy-preserving audit routing.

The broader architecture may include medical, education, family, government, AI-agent, resource, public-service, and industry embodiments. Those embodiments are not imported into the present claims as independent fields of protection; they are contextual examples showing that the monetary layer can interoperate with other BEI/ATMS root-object systems when a monetary or value transition is involved.

### TECHNICAL EFFECTS

The infrastructure improves computer operation by replacing ambiguous account or token references with machine-verifiable monetary state objects that include authority, rule-version, lifecycle, digest, ledger, policy, privacy, and receipt fields.

The infrastructure improves cross-system interoperability because banks, wallets, exchanges, auditors, regulators, merchants, enterprise ledgers, and domain-rooted applications can verify a common monetary state representation without operating a common database.

The infrastructure improves data integrity through prior-state digests, event digests, append-only lifecycle ledger events, rule-version pinning, and receipt signatures or verification material.

The infrastructure improves security by preventing unauthorized state transitions, stale rule use, replayed requests, duplicate value intervals, invalid authority scope, rollback attempts, and mismatched privacy-boundary disclosures.

The infrastructure improves auditability by preserving freeze receipts, revocation receipts, recovery receipts, replacement receipts, conversion receipts, settlement receipts, publication receipts, and governance-update receipts.

The infrastructure improves privacy by allowing selective verification of monetary state without exposing full account data, protected data, or confidential institutional information unless an applicable policy container authorizes disclosure.

The infrastructure improves asset-package and licensing value because the protected core can be implemented as bank middleware, wallet SDK, exchange custody verification, stable-value audit service, CBDC gateway, Trust Receipt service, ATMS clearing component, BEIMINT monetary-state service, or SovMonetary infrastructure layer.

### COMPUTER IMPLEMENTATION

Processors may include general-purpose processors, digital signal processors, secure enclave processors, hardware security modules, trusted execution environments, ledger nodes, cloud processors, edge devices, or institutional servers.

Memories and data stores may include relational databases, key-value stores, object stores, append-only logs, distributed ledgers, secure audit logs, encrypted storage, or hybrid data structures.

Cryptographic material may include public-key signatures, hash commitments, Merkle proofs, zero-knowledge proofs, verifiable credentials, encrypted references, key-rotation records, nonce challenges, and time-stamp tokens.

Network interfaces may include REST APIs, message queues, webhooks, wallet protocols, bank middleware interfaces, exchange custody APIs, regulator portals, auditor consoles, SDK functions, and command-line verification tools.

No embodiment requires a particular blockchain, token standard, domain registrar, cloud platform, database vendor, banking rail, payment network, or jurisdiction-specific legal status.

### CLAIM SUPPORT SUMMARY

Independent claim 1 is supported by the trusted-root identifier-based monetary authority registry, rule-version engine, issuance and lifecycle controller, lifecycle ledger, and monetary receipt generator described throughout the specification and drawings.

Independent claim 16 is supported by the computer-implemented method for resolving authority, normalizing monetary state, pinning rule version, validating lifecycle predicates, recording lifecycle events, and generating monetary receipts.

Independent claim 20 is supported by the computer-readable medium disclosure and the executable operations described in the detailed description, algorithms, API embodiments, and computer implementation section.

Dependent claims 2-15 are supported by monetary state object fields, cross-system verification, rule-version pinning, lifecycle ledger event fields, freeze, revocation, recovery, conversion, receipt types, external verification endpoint, domain-rooted registry embodiments, privacy-preserving audit routing, universal object specialization, and conflict detection.

Dependent claims 17-19 are supported by the representative monetary classes, digest publication, external verifier interactions, and privacy-preserving verification embodiments.

### CONCLUSION

The invention is directed to a concrete technical solution to a monetary infrastructure problem: heterogeneous monetary systems lack a common, machine-verifiable, rule-version-pinned monetary state object and receipt model for lifecycle governance.

The disclosed infrastructure provides a focused monetary-state governance layer. It does not rely on claiming abstract monetary policy, generic business rules, or ownership of all financial systems.

The monetary state object, authority registry, rule-version engine, lifecycle ledger, and monetary receipt together provide a practical key for making money, deposits, tokens, value units, and currency-like instruments more verifiable, governable, recoverable, auditable, and interoperable.

The embodiments are illustrative and not limiting. Features described in separate embodiments may be combined where technically compatible. The scope is defined by the claims as filed and as amended during prosecution.

### EXPANDED ENABLEMENT AND IMPLEMENTATION DETAILS

The following expanded embodiments are provided to increase written-description and enablement support for the monetary state governance infrastructure without broadening the claims away from the five-part monetary core. Each embodiment is non-limiting and may be used alone or in combination with other embodiments where technically compatible.

### Expanded Monetary State Object Field Support

The mso_id field uniquely identifies the monetary state object within a trusted-root namespace. In operation, the field is read by the lifecycle controller, rule-version engine, monetary receipt generator, or external verification endpoint before a monetary state is accepted, synchronized, or returned to a verifier.

The mso_id field is used to detect duplicate object creation, replayed object references, and unauthorized object substitution. In operation, the field is read by the lifecycle controller, rule-version engine, monetary receipt generator, or external verification endpoint before a monetary state is accepted, synchronized, or returned to a verifier.

The mso_id field may be derived from a hash of issuer reference, monetary class, creation interval, nonce, and rule-version reference. In operation, the field is read by the lifecycle controller, rule-version engine, monetary receipt generator, or external verification endpoint before a monetary state is accepted, synchronized, or returned to a verifier.

The root_monetary_identifier field anchors the monetary state object to a trusted-root monetary authority. In operation, the field is read by the lifecycle controller, rule-version engine, monetary receipt generator, or external verification endpoint before a monetary state is accepted, synchronized, or returned to a verifier.

The root_monetary_identifier field allows external verifiers to resolve the appropriate registry path before verifying a receipt. In operation, the field is read by the lifecycle controller, rule-version engine, monetary receipt generator, or external verification endpoint before a monetary state is accepted, synchronized, or returned to a verifier.

The root_monetary_identifier field may be implemented using a domain name, subdomain, institutional namespace, decentralized name, or hybrid naming root. In operation, the field is read by the lifecycle controller, rule-version engine, monetary receipt generator, or external verification endpoint before a monetary state is accepted, synchronized, or returned to a verifier.

The monetary_class field identifies whether the object represents fiat-linked value, commercial-bank deposit, tokenized deposit, verified deposit, CBDC gateway value, stable-value instrument, time-currency unit, behavior-currency unit, enterprise credit, reserve unit, or benefit unit. In operation, the field is read by the lifecycle controller, rule-version engine, monetary receipt generator, or external verification endpoint before a monetary state is accepted, synchronized, or returned to a verifier.

The monetary_class field is evaluated before transfer, conversion, freeze, or settlement because each class may have different permitted transitions. In operation, the field is read by the lifecycle controller, rule-version engine, monetary receipt generator, or external verification endpoint before a monetary state is accepted, synchronized, or returned to a verifier.

The monetary_class field may be mapped to one or more regulatory, accounting, settlement, or custody taxonomies. In operation, the field is read by the lifecycle controller, rule-version engine, monetary receipt generator, or external verification endpoint before a monetary state is accepted, synchronized, or returned to a verifier.

The issuer_ref field identifies the issuing authority or issuer record. In operation, the field is read by the lifecycle controller, rule-version engine, monetary receipt generator, or external verification endpoint before a monetary state is accepted, synchronized, or returned to a verifier.

The issuer_ref field is checked against the issuer authority scope in the registry. In operation, the field is read by the lifecycle controller, rule-version engine, monetary receipt generator, or external verification endpoint before a monetary state is accepted, synchronized, or returned to a verifier.

The issuer_ref field may include delegated authority, historical issuer keys, and issuer revocation status. In operation, the field is read by the lifecycle controller, rule-version engine, monetary receipt generator, or external verification endpoint before a monetary state is accepted, synchronized, or returned to a verifier.

The custody_ref field identifies a wallet, bank, custodian, escrow, exchange, treasury, or institutional holding environment. In operation, the field is read by the lifecycle controller, rule-version engine, monetary receipt generator, or external verification endpoint before a monetary state is accepted, synchronized, or returned to a verifier.

The custody_ref field does not by itself prove ownership unless it is verified with authority and policy conditions. In operation, the field is read by the lifecycle controller, rule-version engine, monetary receipt generator, or external verification endpoint before a monetary state is accepted, synchronized, or returned to a verifier.

The custody_ref field may be updated only through permitted lifecycle transitions. In operation, the field is read by the lifecycle controller, rule-version engine, monetary receipt generator, or external verification endpoint before a monetary state is accepted, synchronized, or returned to a verifier.

The rule_version_ref field pins the object or transition to a specific rule version. In operation, the field is read by the lifecycle controller, rule-version engine, monetary receipt generator, or external verification endpoint before a monetary state is accepted, synchronized, or returned to a verifier.

The rule_version_ref field prevents later policy changes from being silently applied to earlier events. In operation, the field is read by the lifecycle controller, rule-version engine, monetary receipt generator, or external verification endpoint before a monetary state is accepted, synchronized, or returned to a verifier.

The rule_version_ref field is stored in both the lifecycle ledger event and the generated monetary receipt. In operation, the field is read by the lifecycle controller, rule-version engine, monetary receipt generator, or external verification endpoint before a monetary state is accepted, synchronized, or returned to a verifier.

The policy_container_ref field points to a policy container that may include issuance, transfer, settlement, freeze, revocation, recovery, conversion, disclosure, and audit rules. In operation, the field is read by the lifecycle controller, rule-version engine, monetary receipt generator, or external verification endpoint before a monetary state is accepted, synchronized, or returned to a verifier.

The policy_container_ref field may be locally stored, registry stored, signed, hashed, encrypted, or referenced by digest. In operation, the field is read by the lifecycle controller, rule-version engine, monetary receipt generator, or external verification endpoint before a monetary state is accepted, synchronized, or returned to a verifier.

The policy_container_ref field is evaluated before a downstream state transition is accepted. In operation, the field is read by the lifecycle controller, rule-version engine, monetary receipt generator, or external verification endpoint before a monetary state is accepted, synchronized, or returned to a verifier.

The privacy_boundary_ref field identifies what data may be disclosed to which verifier roles. In operation, the field is read by the lifecycle controller, rule-version engine, monetary receipt generator, or external verification endpoint before a monetary state is accepted, synchronized, or returned to a verifier.

The privacy_boundary_ref field allows receipt verification without uncontrolled disclosure of underlying account or customer records. In operation, the field is read by the lifecycle controller, rule-version engine, monetary receipt generator, or external verification endpoint before a monetary state is accepted, synchronized, or returned to a verifier.

The privacy_boundary_ref field may be updated by governance receipt or policy update receipt. In operation, the field is read by the lifecycle controller, rule-version engine, monetary receipt generator, or external verification endpoint before a monetary state is accepted, synchronized, or returned to a verifier.

The prior_state_digest field links a proposed transition to the immediately prior accepted lifecycle state. In operation, the field is read by the lifecycle controller, rule-version engine, monetary receipt generator, or external verification endpoint before a monetary state is accepted, synchronized, or returned to a verifier.

The prior_state_digest field prevents hidden rollback, branch substitution, or unsupported state rewriting. In operation, the field is read by the lifecycle controller, rule-version engine, monetary receipt generator, or external verification endpoint before a monetary state is accepted, synchronized, or returned to a verifier.

The prior_state_digest field is included in the monetary receipt so an external verifier can detect discontinuity. In operation, the field is read by the lifecycle controller, rule-version engine, monetary receipt generator, or external verification endpoint before a monetary state is accepted, synchronized, or returned to a verifier.

The event_digest field summarizes the transition event, request payload, state result, authority record, and rule-version result. In operation, the field is read by the lifecycle controller, rule-version engine, monetary receipt generator, or external verification endpoint before a monetary state is accepted, synchronized, or returned to a verifier.

The event_digest field may be computed using a cryptographic hash function or hash commitment. In operation, the field is read by the lifecycle controller, rule-version engine, monetary receipt generator, or external verification endpoint before a monetary state is accepted, synchronized, or returned to a verifier.

The event_digest field is compared against receipt material during verification. In operation, the field is read by the lifecycle controller, rule-version engine, monetary receipt generator, or external verification endpoint before a monetary state is accepted, synchronized, or returned to a verifier.

The ledger_ref field identifies an append-only ledger event or ledger segment. In operation, the field is read by the lifecycle controller, rule-version engine, monetary receipt generator, or external verification endpoint before a monetary state is accepted, synchronized, or returned to a verifier.

The ledger_ref field may point to an institutional database entry, distributed ledger transaction, secure log record, or hybrid record. In operation, the field is read by the lifecycle controller, rule-version engine, monetary receipt generator, or external verification endpoint before a monetary state is accepted, synchronized, or returned to a verifier.

The ledger_ref field allows reconciliation between receipt output and internal settlement history. In operation, the field is read by the lifecycle controller, rule-version engine, monetary receipt generator, or external verification endpoint before a monetary state is accepted, synchronized, or returned to a verifier.

The receipt_ref field identifies the receipt generated for the transition. In operation, the field is read by the lifecycle controller, rule-version engine, monetary receipt generator, or external verification endpoint before a monetary state is accepted, synchronized, or returned to a verifier.

The receipt_ref field links external verification to the lifecycle ledger event. In operation, the field is read by the lifecycle controller, rule-version engine, monetary receipt generator, or external verification endpoint before a monetary state is accepted, synchronized, or returned to a verifier.

The receipt_ref field may be published as digest-only, encrypted, signed, or fully disclosed according to policy. In operation, the field is read by the lifecycle controller, rule-version engine, monetary receipt generator, or external verification endpoint before a monetary state is accepted, synchronized, or returned to a verifier.

The permitted_next_states field lists the next lifecycle states permitted by the applicable rule version. In operation, the field is read by the lifecycle controller, rule-version engine, monetary receipt generator, or external verification endpoint before a monetary state is accepted, synchronized, or returned to a verifier.

The permitted_next_states field is checked before transition execution. In operation, the field is read by the lifecycle controller, rule-version engine, monetary receipt generator, or external verification endpoint before a monetary state is accepted, synchronized, or returned to a verifier.

The permitted_next_states field may differ by monetary class, jurisdiction, authority scope, and risk state. In operation, the field is read by the lifecycle controller, rule-version engine, monetary receipt generator, or external verification endpoint before a monetary state is accepted, synchronized, or returned to a verifier.

The recovery_state field records whether an object is normal, held, recovered, replaced, revoked, or archived. In operation, the field is read by the lifecycle controller, rule-version engine, monetary receipt generator, or external verification endpoint before a monetary state is accepted, synchronized, or returned to a verifier.

The recovery_state field supports non-destructive correction and replacement. In operation, the field is read by the lifecycle controller, rule-version engine, monetary receipt generator, or external verification endpoint before a monetary state is accepted, synchronized, or returned to a verifier.

The recovery_state field is used by wallets, banks, exchanges, and auditors before accepting downstream value movement. In operation, the field is read by the lifecycle controller, rule-version engine, monetary receipt generator, or external verification endpoint before a monetary state is accepted, synchronized, or returned to a verifier.

The publication_state field records whether a receipt, digest, revocation, recovery, or verification response has been published. In operation, the field is read by the lifecycle controller, rule-version engine, monetary receipt generator, or external verification endpoint before a monetary state is accepted, synchronized, or returned to a verifier.

The publication_state field supports public verification while preserving private data. In operation, the field is read by the lifecycle controller, rule-version engine, monetary receipt generator, or external verification endpoint before a monetary state is accepted, synchronized, or returned to a verifier.

The publication_state field may be synchronized across trusted-root or domain-rooted registries. In operation, the field is read by the lifecycle controller, rule-version engine, monetary receipt generator, or external verification endpoint before a monetary state is accepted, synchronized, or returned to a verifier.

The signature_state field records whether a receipt or transition event is unsigned, signature-ready, signed, sealed, countersigned, expired, revoked, or verified. In operation, the field is read by the lifecycle controller, rule-version engine, monetary receipt generator, or external verification endpoint before a monetary state is accepted, synchronized, or returned to a verifier.

The signature_state field supports key rotation and authority-history validation. In operation, the field is read by the lifecycle controller, rule-version engine, monetary receipt generator, or external verification endpoint before a monetary state is accepted, synchronized, or returned to a verifier.

The signature_state field may be checked by a hardware security module or software cryptographic service. In operation, the field is read by the lifecycle controller, rule-version engine, monetary receipt generator, or external verification endpoint before a monetary state is accepted, synchronized, or returned to a verifier.

### Expanded Monetary Receipt Schema

A monetary receipt may include a receipt_id field. The receipt_id field allows the receipt to be processed as a machine-verifiable evidence object rather than as an informal transaction message.

When the receipt_id field is present, the verification endpoint may compare the field against registry data, lifecycle ledger data, policy-container data, or cryptographic proof material before returning a verification response.

A monetary receipt may include a receipt_type field. The receipt_type field allows the receipt to be processed as a machine-verifiable evidence object rather than as an informal transaction message.

When the receipt_type field is present, the verification endpoint may compare the field against registry data, lifecycle ledger data, policy-container data, or cryptographic proof material before returning a verification response.

A monetary receipt may include a mso_id field. The mso_id field allows the receipt to be processed as a machine-verifiable evidence object rather than as an informal transaction message.

When the mso_id field is present, the verification endpoint may compare the field against registry data, lifecycle ledger data, policy-container data, or cryptographic proof material before returning a verification response.

A monetary receipt may include a root_monetary_identifier field. The root_monetary_identifier field allows the receipt to be processed as a machine-verifiable evidence object rather than as an informal transaction message.

When the root_monetary_identifier field is present, the verification endpoint may compare the field against registry data, lifecycle ledger data, policy-container data, or cryptographic proof material before returning a verification response.

A monetary receipt may include a authority_record_id field. The authority_record_id field allows the receipt to be processed as a machine-verifiable evidence object rather than as an informal transaction message.

When the authority_record_id field is present, the verification endpoint may compare the field against registry data, lifecycle ledger data, policy-container data, or cryptographic proof material before returning a verification response.

A monetary receipt may include a rule_version_id field. The rule_version_id field allows the receipt to be processed as a machine-verifiable evidence object rather than as an informal transaction message.

When the rule_version_id field is present, the verification endpoint may compare the field against registry data, lifecycle ledger data, policy-container data, or cryptographic proof material before returning a verification response.

A monetary receipt may include a prior_state_digest field. The prior_state_digest field allows the receipt to be processed as a machine-verifiable evidence object rather than as an informal transaction message.

When the prior_state_digest field is present, the verification endpoint may compare the field against registry data, lifecycle ledger data, policy-container data, or cryptographic proof material before returning a verification response.

A monetary receipt may include a event_digest field. The event_digest field allows the receipt to be processed as a machine-verifiable evidence object rather than as an informal transaction message.

When the event_digest field is present, the verification endpoint may compare the field against registry data, lifecycle ledger data, policy-container data, or cryptographic proof material before returning a verification response.

A monetary receipt may include a current_state_digest field. The current_state_digest field allows the receipt to be processed as a machine-verifiable evidence object rather than as an informal transaction message.

When the current_state_digest field is present, the verification endpoint may compare the field against registry data, lifecycle ledger data, policy-container data, or cryptographic proof material before returning a verification response.

A monetary receipt may include a lifecycle_result field. The lifecycle_result field allows the receipt to be processed as a machine-verifiable evidence object rather than as an informal transaction message.

When the lifecycle_result field is present, the verification endpoint may compare the field against registry data, lifecycle ledger data, policy-container data, or cryptographic proof material before returning a verification response.

A monetary receipt may include a policy_result field. The policy_result field allows the receipt to be processed as a machine-verifiable evidence object rather than as an informal transaction message.

When the policy_result field is present, the verification endpoint may compare the field against registry data, lifecycle ledger data, policy-container data, or cryptographic proof material before returning a verification response.

A monetary receipt may include a privacy_boundary_status field. The privacy_boundary_status field allows the receipt to be processed as a machine-verifiable evidence object rather than as an informal transaction message.

When the privacy_boundary_status field is present, the verification endpoint may compare the field against registry data, lifecycle ledger data, policy-container data, or cryptographic proof material before returning a verification response.

A monetary receipt may include a issuer_status field. The issuer_status field allows the receipt to be processed as a machine-verifiable evidence object rather than as an informal transaction message.

When the issuer_status field is present, the verification endpoint may compare the field against registry data, lifecycle ledger data, policy-container data, or cryptographic proof material before returning a verification response.

A monetary receipt may include a settlement_status field. The settlement_status field allows the receipt to be processed as a machine-verifiable evidence object rather than as an informal transaction message.

When the settlement_status field is present, the verification endpoint may compare the field against registry data, lifecycle ledger data, policy-container data, or cryptographic proof material before returning a verification response.

A monetary receipt may include a freeze_status field. The freeze_status field allows the receipt to be processed as a machine-verifiable evidence object rather than as an informal transaction message.

When the freeze_status field is present, the verification endpoint may compare the field against registry data, lifecycle ledger data, policy-container data, or cryptographic proof material before returning a verification response.

A monetary receipt may include a recovery_status field. The recovery_status field allows the receipt to be processed as a machine-verifiable evidence object rather than as an informal transaction message.

When the recovery_status field is present, the verification endpoint may compare the field against registry data, lifecycle ledger data, policy-container data, or cryptographic proof material before returning a verification response.

A monetary receipt may include a conversion_status field. The conversion_status field allows the receipt to be processed as a machine-verifiable evidence object rather than as an informal transaction message.

When the conversion_status field is present, the verification endpoint may compare the field against registry data, lifecycle ledger data, policy-container data, or cryptographic proof material before returning a verification response.

A monetary receipt may include a audit_scope field. The audit_scope field allows the receipt to be processed as a machine-verifiable evidence object rather than as an informal transaction message.

When the audit_scope field is present, the verification endpoint may compare the field against registry data, lifecycle ledger data, policy-container data, or cryptographic proof material before returning a verification response.

A monetary receipt may include a publication_scope field. The publication_scope field allows the receipt to be processed as a machine-verifiable evidence object rather than as an informal transaction message.

When the publication_scope field is present, the verification endpoint may compare the field against registry data, lifecycle ledger data, policy-container data, or cryptographic proof material before returning a verification response.

A monetary receipt may include a signature_material field. The signature_material field allows the receipt to be processed as a machine-verifiable evidence object rather than as an informal transaction message.

When the signature_material field is present, the verification endpoint may compare the field against registry data, lifecycle ledger data, policy-container data, or cryptographic proof material before returning a verification response.

A monetary receipt may include a verification_endpoint field. The verification_endpoint field allows the receipt to be processed as a machine-verifiable evidence object rather than as an informal transaction message.

When the verification_endpoint field is present, the verification endpoint may compare the field against registry data, lifecycle ledger data, policy-container data, or cryptographic proof material before returning a verification response.

A monetary receipt may include a timestamp_or_interval field. The timestamp_or_interval field allows the receipt to be processed as a machine-verifiable evidence object rather than as an informal transaction message.

When the timestamp_or_interval field is present, the verification endpoint may compare the field against registry data, lifecycle ledger data, policy-container data, or cryptographic proof material before returning a verification response.

A monetary receipt may include a jurisdiction_reference field. The jurisdiction_reference field allows the receipt to be processed as a machine-verifiable evidence object rather than as an informal transaction message.

When the jurisdiction_reference field is present, the verification endpoint may compare the field against registry data, lifecycle ledger data, policy-container data, or cryptographic proof material before returning a verification response.

A monetary receipt may include a external_verifier_role field. The external_verifier_role field allows the receipt to be processed as a machine-verifiable evidence object rather than as an informal transaction message.

When the external_verifier_role field is present, the verification endpoint may compare the field against registry data, lifecycle ledger data, policy-container data, or cryptographic proof material before returning a verification response.

A monetary receipt may include a redaction_profile field. The redaction_profile field allows the receipt to be processed as a machine-verifiable evidence object rather than as an informal transaction message.

When the redaction_profile field is present, the verification endpoint may compare the field against registry data, lifecycle ledger data, policy-container data, or cryptographic proof material before returning a verification response.

A monetary receipt may include a selective_disclosure_profile field. The selective_disclosure_profile field allows the receipt to be processed as a machine-verifiable evidence object rather than as an informal transaction message.

When the selective_disclosure_profile field is present, the verification endpoint may compare the field against registry data, lifecycle ledger data, policy-container data, or cryptographic proof material before returning a verification response.

A monetary receipt may include a receipt_chain_reference field. The receipt_chain_reference field allows the receipt to be processed as a machine-verifiable evidence object rather than as an informal transaction message.

When the receipt_chain_reference field is present, the verification endpoint may compare the field against registry data, lifecycle ledger data, policy-container data, or cryptographic proof material before returning a verification response.

A monetary receipt may include a governance_update_reference field. The governance_update_reference field allows the receipt to be processed as a machine-verifiable evidence object rather than as an informal transaction message.

When the governance_update_reference field is present, the verification endpoint may compare the field against registry data, lifecycle ledger data, policy-container data, or cryptographic proof material before returning a verification response.

A monetary receipt may include a archive_reference field. The archive_reference field allows the receipt to be processed as a machine-verifiable evidence object rather than as an informal transaction message.

When the archive_reference field is present, the verification endpoint may compare the field against registry data, lifecycle ledger data, policy-container data, or cryptographic proof material before returning a verification response.

A monetary receipt may include a permitted_next_state field. The permitted_next_state field allows the receipt to be processed as a machine-verifiable evidence object rather than as an informal transaction message.

When the permitted_next_state field is present, the verification endpoint may compare the field against registry data, lifecycle ledger data, policy-container data, or cryptographic proof material before returning a verification response.

### Detailed State Transition Matrix

A transition from created to issued may be permitted when issuer authority and valid issuance rule. The transition event stores the prior-state digest, current-state digest, rule-version identifier, authority record, and receipt reference.

A transition from created to issued may be rejected or held when the pinned rule version does not authorize the transition, the authority scope is invalid, the prior-state digest does not match, or the privacy boundary blocks the requested verification path.

A transition from issued to active may be permitted when activation policy and reserve or provenance check. The transition event stores the prior-state digest, current-state digest, rule-version identifier, authority record, and receipt reference.

A transition from issued to active may be rejected or held when the pinned rule version does not authorize the transition, the authority scope is invalid, the prior-state digest does not match, or the privacy boundary blocks the requested verification path.

A transition from active to pending may be permitted when transfer, conversion, or settlement request accepted. The transition event stores the prior-state digest, current-state digest, rule-version identifier, authority record, and receipt reference.

A transition from active to pending may be rejected or held when the pinned rule version does not authorize the transition, the authority scope is invalid, the prior-state digest does not match, or the privacy boundary blocks the requested verification path.

A transition from pending to settled may be permitted when finality condition and ledger confirmation. The transition event stores the prior-state digest, current-state digest, rule-version identifier, authority record, and receipt reference.

A transition from pending to settled may be rejected or held when the pinned rule version does not authorize the transition, the authority scope is invalid, the prior-state digest does not match, or the privacy boundary blocks the requested verification path.

A transition from active to held may be permitted when risk, dispute, or manual review trigger. The transition event stores the prior-state digest, current-state digest, rule-version identifier, authority record, and receipt reference.

A transition from active to held may be rejected or held when the pinned rule version does not authorize the transition, the authority scope is invalid, the prior-state digest does not match, or the privacy boundary blocks the requested verification path.

A transition from pending to held may be permitted when conflict, stale rule, privacy mismatch, or invalid verifier role. The transition event stores the prior-state digest, current-state digest, rule-version identifier, authority record, and receipt reference.

A transition from pending to held may be rejected or held when the pinned rule version does not authorize the transition, the authority scope is invalid, the prior-state digest does not match, or the privacy boundary blocks the requested verification path.

A transition from held to active may be permitted when review clears conflict and permitted next-state list allows release. The transition event stores the prior-state digest, current-state digest, rule-version identifier, authority record, and receipt reference.

A transition from held to active may be rejected or held when the pinned rule version does not authorize the transition, the authority scope is invalid, the prior-state digest does not match, or the privacy boundary blocks the requested verification path.

A transition from held to frozen may be permitted when freeze authority issues freeze result. The transition event stores the prior-state digest, current-state digest, rule-version identifier, authority record, and receipt reference.

A transition from held to frozen may be rejected or held when the pinned rule version does not authorize the transition, the authority scope is invalid, the prior-state digest does not match, or the privacy boundary blocks the requested verification path.

A transition from frozen to recovered may be permitted when recovery authority authorizes replacement or restoration. The transition event stores the prior-state digest, current-state digest, rule-version identifier, authority record, and receipt reference.

A transition from frozen to recovered may be rejected or held when the pinned rule version does not authorize the transition, the authority scope is invalid, the prior-state digest does not match, or the privacy boundary blocks the requested verification path.

A transition from frozen to revoked may be permitted when revocation authority authorizes revocation. The transition event stores the prior-state digest, current-state digest, rule-version identifier, authority record, and receipt reference.

A transition from frozen to revoked may be rejected or held when the pinned rule version does not authorize the transition, the authority scope is invalid, the prior-state digest does not match, or the privacy boundary blocks the requested verification path.

A transition from revoked to archived may be permitted when archive rule records final non-use status. The transition event stores the prior-state digest, current-state digest, rule-version identifier, authority record, and receipt reference.

A transition from revoked to archived may be rejected or held when the pinned rule version does not authorize the transition, the authority scope is invalid, the prior-state digest does not match, or the privacy boundary blocks the requested verification path.

A transition from revoked to recovered may be permitted when replacement object created and linked by recovery receipt. The transition event stores the prior-state digest, current-state digest, rule-version identifier, authority record, and receipt reference.

A transition from revoked to recovered may be rejected or held when the pinned rule version does not authorize the transition, the authority scope is invalid, the prior-state digest does not match, or the privacy boundary blocks the requested verification path.

A transition from active to converted may be permitted when conversion rule version maps source class to destination class. The transition event stores the prior-state digest, current-state digest, rule-version identifier, authority record, and receipt reference.

A transition from active to converted may be rejected or held when the pinned rule version does not authorize the transition, the authority scope is invalid, the prior-state digest does not match, or the privacy boundary blocks the requested verification path.

A transition from converted to active may be permitted when destination object passes activation predicates. The transition event stores the prior-state digest, current-state digest, rule-version identifier, authority record, and receipt reference.

A transition from converted to active may be rejected or held when the pinned rule version does not authorize the transition, the authority scope is invalid, the prior-state digest does not match, or the privacy boundary blocks the requested verification path.

A transition from settled to archived may be permitted when retention and audit rules allow archiving. The transition event stores the prior-state digest, current-state digest, rule-version identifier, authority record, and receipt reference.

A transition from settled to archived may be rejected or held when the pinned rule version does not authorize the transition, the authority scope is invalid, the prior-state digest does not match, or the privacy boundary blocks the requested verification path.

A transition from expired to archived may be permitted when expiration has been recorded and no replacement is authorized. The transition event stores the prior-state digest, current-state digest, rule-version identifier, authority record, and receipt reference.

A transition from expired to archived may be rejected or held when the pinned rule version does not authorize the transition, the authority scope is invalid, the prior-state digest does not match, or the privacy boundary blocks the requested verification path.

A transition from expired to recovered may be permitted when reissue by new object is authorized. The transition event stores the prior-state digest, current-state digest, rule-version identifier, authority record, and receipt reference.

A transition from expired to recovered may be rejected or held when the pinned rule version does not authorize the transition, the authority scope is invalid, the prior-state digest does not match, or the privacy boundary blocks the requested verification path.

A transition from any reviewable state to under-review may be permitted when manual review or external verification challenge is received. The transition event stores the prior-state digest, current-state digest, rule-version identifier, authority record, and receipt reference.

A transition from any reviewable state to under-review may be rejected or held when the pinned rule version does not authorize the transition, the authority scope is invalid, the prior-state digest does not match, or the privacy boundary blocks the requested verification path.

### Conflict Codes and Rejection Conditions

Conflict code C001 may correspond to duplicate object identifier. When the rule-version engine detects this condition, the infrastructure may block the transition, place the object in a held state, generate a conflict receipt, or route the event to manual review according to the policy container.

Conflict code C002 may correspond to duplicate value interval. When the rule-version engine detects this condition, the infrastructure may block the transition, place the object in a held state, generate a conflict receipt, or route the event to manual review according to the policy container.

Conflict code C003 may correspond to replayed nonce. When the rule-version engine detects this condition, the infrastructure may block the transition, place the object in a held state, generate a conflict receipt, or route the event to manual review according to the policy container.

Conflict code C004 may correspond to stale rule version. When the rule-version engine detects this condition, the infrastructure may block the transition, place the object in a held state, generate a conflict receipt, or route the event to manual review according to the policy container.

Conflict code C005 may correspond to superseded policy container. When the rule-version engine detects this condition, the infrastructure may block the transition, place the object in a held state, generate a conflict receipt, or route the event to manual review according to the policy container.

Conflict code C006 may correspond to invalid issuer authority. When the rule-version engine detects this condition, the infrastructure may block the transition, place the object in a held state, generate a conflict receipt, or route the event to manual review according to the policy container.

Conflict code C007 may correspond to invalid settlement authority. When the rule-version engine detects this condition, the infrastructure may block the transition, place the object in a held state, generate a conflict receipt, or route the event to manual review according to the policy container.

Conflict code C008 may correspond to invalid freeze authority. When the rule-version engine detects this condition, the infrastructure may block the transition, place the object in a held state, generate a conflict receipt, or route the event to manual review according to the policy container.

Conflict code C009 may correspond to invalid recovery authority. When the rule-version engine detects this condition, the infrastructure may block the transition, place the object in a held state, generate a conflict receipt, or route the event to manual review according to the policy container.

Conflict code C010 may correspond to invalid conversion authority. When the rule-version engine detects this condition, the infrastructure may block the transition, place the object in a held state, generate a conflict receipt, or route the event to manual review according to the policy container.

Conflict code C011 may correspond to expired credential. When the rule-version engine detects this condition, the infrastructure may block the transition, place the object in a held state, generate a conflict receipt, or route the event to manual review according to the policy container.

Conflict code C012 may correspond to revoked credential. When the rule-version engine detects this condition, the infrastructure may block the transition, place the object in a held state, generate a conflict receipt, or route the event to manual review according to the policy container.

Conflict code C013 may correspond to missing reserve reference. When the rule-version engine detects this condition, the infrastructure may block the transition, place the object in a held state, generate a conflict receipt, or route the event to manual review according to the policy container.

Conflict code C014 may correspond to mismatched reserve reference. When the rule-version engine detects this condition, the infrastructure may block the transition, place the object in a held state, generate a conflict receipt, or route the event to manual review according to the policy container.

Conflict code C015 may correspond to invalid provenance reference. When the rule-version engine detects this condition, the infrastructure may block the transition, place the object in a held state, generate a conflict receipt, or route the event to manual review according to the policy container.

Conflict code C016 may correspond to ledger rollback condition. When the rule-version engine detects this condition, the infrastructure may block the transition, place the object in a held state, generate a conflict receipt, or route the event to manual review according to the policy container.

Conflict code C017 may correspond to ledger fork condition. When the rule-version engine detects this condition, the infrastructure may block the transition, place the object in a held state, generate a conflict receipt, or route the event to manual review according to the policy container.

Conflict code C018 may correspond to prior-state digest mismatch. When the rule-version engine detects this condition, the infrastructure may block the transition, place the object in a held state, generate a conflict receipt, or route the event to manual review according to the policy container.

Conflict code C019 may correspond to event digest mismatch. When the rule-version engine detects this condition, the infrastructure may block the transition, place the object in a held state, generate a conflict receipt, or route the event to manual review according to the policy container.

Conflict code C020 may correspond to signature verification failure. When the rule-version engine detects this condition, the infrastructure may block the transition, place the object in a held state, generate a conflict receipt, or route the event to manual review according to the policy container.

Conflict code C021 may correspond to key history mismatch. When the rule-version engine detects this condition, the infrastructure may block the transition, place the object in a held state, generate a conflict receipt, or route the event to manual review according to the policy container.

Conflict code C022 may correspond to privacy-boundary mismatch. When the rule-version engine detects this condition, the infrastructure may block the transition, place the object in a held state, generate a conflict receipt, or route the event to manual review according to the policy container.

Conflict code C023 may correspond to unauthorized verifier role. When the rule-version engine detects this condition, the infrastructure may block the transition, place the object in a held state, generate a conflict receipt, or route the event to manual review according to the policy container.

Conflict code C024 may correspond to unpermitted jurisdiction. When the rule-version engine detects this condition, the infrastructure may block the transition, place the object in a held state, generate a conflict receipt, or route the event to manual review according to the policy container.

Conflict code C025 may correspond to sanctions or legal hold condition. When the rule-version engine detects this condition, the infrastructure may block the transition, place the object in a held state, generate a conflict receipt, or route the event to manual review according to the policy container.

Conflict code C026 may correspond to expired time window. When the rule-version engine detects this condition, the infrastructure may block the transition, place the object in a held state, generate a conflict receipt, or route the event to manual review according to the policy container.

Conflict code C027 may correspond to future-dated event. When the rule-version engine detects this condition, the infrastructure may block the transition, place the object in a held state, generate a conflict receipt, or route the event to manual review according to the policy container.

Conflict code C028 may correspond to missing owner or custody reference. When the rule-version engine detects this condition, the infrastructure may block the transition, place the object in a held state, generate a conflict receipt, or route the event to manual review according to the policy container.

Conflict code C029 may correspond to invalid custody transfer. When the rule-version engine detects this condition, the infrastructure may block the transition, place the object in a held state, generate a conflict receipt, or route the event to manual review according to the policy container.

Conflict code C030 may correspond to object already revoked. When the rule-version engine detects this condition, the infrastructure may block the transition, place the object in a held state, generate a conflict receipt, or route the event to manual review according to the policy container.

Conflict code C031 may correspond to object already archived. When the rule-version engine detects this condition, the infrastructure may block the transition, place the object in a held state, generate a conflict receipt, or route the event to manual review according to the policy container.

Conflict code C032 may correspond to object under manual review. When the rule-version engine detects this condition, the infrastructure may block the transition, place the object in a held state, generate a conflict receipt, or route the event to manual review according to the policy container.

Conflict code C033 may correspond to duplicate receipt identifier. When the rule-version engine detects this condition, the infrastructure may block the transition, place the object in a held state, generate a conflict receipt, or route the event to manual review according to the policy container.

Conflict code C034 may correspond to receipt chain discontinuity. When the rule-version engine detects this condition, the infrastructure may block the transition, place the object in a held state, generate a conflict receipt, or route the event to manual review according to the policy container.

Conflict code C035 may correspond to conversion formula mismatch. When the rule-version engine detects this condition, the infrastructure may block the transition, place the object in a held state, generate a conflict receipt, or route the event to manual review according to the policy container.

Conflict code C036 may correspond to insufficient audit scope. When the rule-version engine detects this condition, the infrastructure may block the transition, place the object in a held state, generate a conflict receipt, or route the event to manual review according to the policy container.

Conflict code C037 may correspond to unsupported monetary class. When the rule-version engine detects this condition, the infrastructure may block the transition, place the object in a held state, generate a conflict receipt, or route the event to manual review according to the policy container.

Conflict code C038 may correspond to external system timeout. When the rule-version engine detects this condition, the infrastructure may block the transition, place the object in a held state, generate a conflict receipt, or route the event to manual review according to the policy container.

Conflict code C039 may correspond to cross-domain registry inconsistency. When the rule-version engine detects this condition, the infrastructure may block the transition, place the object in a held state, generate a conflict receipt, or route the event to manual review according to the policy container.

Conflict code C040 may correspond to policy update not yet effective. When the rule-version engine detects this condition, the infrastructure may block the transition, place the object in a held state, generate a conflict receipt, or route the event to manual review according to the policy container.

### API and SDK Examples

The API endpoint POST /mso/create may be used to create an issued monetary state object after authority and rule-version checks. The endpoint may authenticate a verifier, apply a policy container, resolve authority, compute or compare digests, and return a signed or unsigned verification response depending on deployment configuration.

An SDK function corresponding to POST /mso/create may be exposed to bank middleware, wallet software, exchange custody systems, auditor tools, regulator portals, merchant systems, enterprise treasury systems, or BEI/ATMS trusted-root or domain-rooted services.

The API endpoint POST /mso/transition may be used to request a lifecycle transition such as activate, transfer, settle, hold, freeze, revoke, recover, convert, archive, or publish. The endpoint may authenticate a verifier, apply a policy container, resolve authority, compute or compare digests, and return a signed or unsigned verification response depending on deployment configuration.

An SDK function corresponding to POST /mso/transition may be exposed to bank middleware, wallet software, exchange custody systems, auditor tools, regulator portals, merchant systems, enterprise treasury systems, or BEI/ATMS trusted-root or domain-rooted services.

The API endpoint GET /mso/{id}/state may be used to return a policy-authorized state response for a monetary state object. The endpoint may authenticate a verifier, apply a policy container, resolve authority, compute or compare digests, and return a signed or unsigned verification response depending on deployment configuration.

An SDK function corresponding to GET /mso/{id}/state may be exposed to bank middleware, wallet software, exchange custody systems, auditor tools, regulator portals, merchant systems, enterprise treasury systems, or BEI/ATMS trusted-root or domain-rooted services.

The API endpoint GET /receipt/{id}/verify may be used to verify a monetary receipt and returns lifecycle, authority, digest, rule-version, and privacy-boundary status. The endpoint may authenticate a verifier, apply a policy container, resolve authority, compute or compare digests, and return a signed or unsigned verification response depending on deployment configuration.

An SDK function corresponding to GET /receipt/{id}/verify may be exposed to bank middleware, wallet software, exchange custody systems, auditor tools, regulator portals, merchant systems, enterprise treasury systems, or BEI/ATMS trusted-root or domain-rooted services.

The API endpoint POST /receipt/publish may be used to publish a selected digest or receipt reference according to publication policy. The endpoint may authenticate a verifier, apply a policy container, resolve authority, compute or compare digests, and return a signed or unsigned verification response depending on deployment configuration.

An SDK function corresponding to POST /receipt/publish may be exposed to bank middleware, wallet software, exchange custody systems, auditor tools, regulator portals, merchant systems, enterprise treasury systems, or BEI/ATMS trusted-root or domain-rooted services.

The API endpoint POST /authority/resolve may be used to resolve a trusted-root authority record and key history. The endpoint may authenticate a verifier, apply a policy container, resolve authority, compute or compare digests, and return a signed or unsigned verification response depending on deployment configuration.

An SDK function corresponding to POST /authority/resolve may be exposed to bank middleware, wallet software, exchange custody systems, auditor tools, regulator portals, merchant systems, enterprise treasury systems, or BEI/ATMS trusted-root or domain-rooted services.

The API endpoint POST /rule/pin may be used to pin a request to a rule version before evaluation. The endpoint may authenticate a verifier, apply a policy container, resolve authority, compute or compare digests, and return a signed or unsigned verification response depending on deployment configuration.

An SDK function corresponding to POST /rule/pin may be exposed to bank middleware, wallet software, exchange custody systems, auditor tools, regulator portals, merchant systems, enterprise treasury systems, or BEI/ATMS trusted-root or domain-rooted services.

The API endpoint POST /audit/selective-proof may be used to create a selective-disclosure proof or digest-only audit response. The endpoint may authenticate a verifier, apply a policy container, resolve authority, compute or compare digests, and return a signed or unsigned verification response depending on deployment configuration.

An SDK function corresponding to POST /audit/selective-proof may be exposed to bank middleware, wallet software, exchange custody systems, auditor tools, regulator portals, merchant systems, enterprise treasury systems, or BEI/ATMS trusted-root or domain-rooted services.

The API endpoint POST /freeze/request may be used to submit a freeze or hold request. The endpoint may authenticate a verifier, apply a policy container, resolve authority, compute or compare digests, and return a signed or unsigned verification response depending on deployment configuration.

An SDK function corresponding to POST /freeze/request may be exposed to bank middleware, wallet software, exchange custody systems, auditor tools, regulator portals, merchant systems, enterprise treasury systems, or BEI/ATMS trusted-root or domain-rooted services.

The API endpoint POST /recovery/create-replacement may be used to create a replacement object linked by recovery receipt. The endpoint may authenticate a verifier, apply a policy container, resolve authority, compute or compare digests, and return a signed or unsigned verification response depending on deployment configuration.

An SDK function corresponding to POST /recovery/create-replacement may be exposed to bank middleware, wallet software, exchange custody systems, auditor tools, regulator portals, merchant systems, enterprise treasury systems, or BEI/ATMS trusted-root or domain-rooted services.

The API endpoint POST /conversion/request may be used to map a source monetary state object to a destination monetary state object. The endpoint may authenticate a verifier, apply a policy container, resolve authority, compute or compare digests, and return a signed or unsigned verification response depending on deployment configuration.

An SDK function corresponding to POST /conversion/request may be exposed to bank middleware, wallet software, exchange custody systems, auditor tools, regulator portals, merchant systems, enterprise treasury systems, or BEI/ATMS trusted-root or domain-rooted services.

The API endpoint GET /external-verifier/response may be used to return a verifier-specific response without exposing underlying private data. The endpoint may authenticate a verifier, apply a policy container, resolve authority, compute or compare digests, and return a signed or unsigned verification response depending on deployment configuration.

An SDK function corresponding to GET /external-verifier/response may be exposed to bank middleware, wallet software, exchange custody systems, auditor tools, regulator portals, merchant systems, enterprise treasury systems, or BEI/ATMS trusted-root or domain-rooted services.

### JSON-Like Non-Limiting Data Examples

A non-limiting MonetaryStateObject record may be represented as {mso_id, monetary_class, issuer_ref, custody_ref, rule_version_ref, lifecycle_state, prior_state_digest, event_digest, ledger_ref, policy_container_ref, privacy_boundary_ref, receipt_ref}. Field names are illustrative and may be encoded as JSON, JSON-LD, CBOR, protocol buffers, relational columns, ledger fields, signed endpoint records, or another machine-readable format.

The MonetaryStateObject record may include additional fields and may omit fields that are not required for a particular monetary class, verifier role, or deployment environment, provided that the monetary lifecycle verification function remains supported.

A non-limiting MonetaryReceipt record may be represented as {receipt_id, receipt_type, mso_id, authority_record_id, rule_version_id, lifecycle_result, prior_state_digest, event_digest, policy_result, privacy_boundary_status, signature_material}. Field names are illustrative and may be encoded as JSON, JSON-LD, CBOR, protocol buffers, relational columns, ledger fields, signed endpoint records, or another machine-readable format.

The MonetaryReceipt record may include additional fields and may omit fields that are not required for a particular monetary class, verifier role, or deployment environment, provided that the monetary lifecycle verification function remains supported.

A non-limiting AuthorityRecord record may be represented as {root_monetary_identifier, authority_type, authority_scope, key_history_ref, validity_interval, delegation_ref, revocation_state, rule_version_scope}. Field names are illustrative and may be encoded as JSON, JSON-LD, CBOR, protocol buffers, relational columns, ledger fields, signed endpoint records, or another machine-readable format.

The AuthorityRecord record may include additional fields and may omit fields that are not required for a particular monetary class, verifier role, or deployment environment, provided that the monetary lifecycle verification function remains supported.

A non-limiting VerificationResponse record may be represented as {receipt_id, lifecycle_state, authority_status, rule_version_status, prior_state_digest_status, event_digest_status, policy_result, privacy_boundary_status, permitted_next_state}. Field names are illustrative and may be encoded as JSON, JSON-LD, CBOR, protocol buffers, relational columns, ledger fields, signed endpoint records, or another machine-readable format.

The VerificationResponse record may include additional fields and may omit fields that are not required for a particular monetary class, verifier role, or deployment environment, provided that the monetary lifecycle verification function remains supported.

A non-limiting PolicyContainer record may be represented as {policy_id, rule_version_id, monetary_class_rules, jurisdiction_rules, privacy_rules, freeze_rules, recovery_rules, conversion_rules, audit_rules, publication_rules}. Field names are illustrative and may be encoded as JSON, JSON-LD, CBOR, protocol buffers, relational columns, ledger fields, signed endpoint records, or another machine-readable format.

The PolicyContainer record may include additional fields and may omit fields that are not required for a particular monetary class, verifier role, or deployment environment, provided that the monetary lifecycle verification function remains supported.

### ADS and Related-Application Technical Walls

The ATMS/Banking/Finance/Settlement technical wall may provide related support for domain-resolved banking, payment routing, treasury, collateral, lending, settlement, reserve, currency exchange, and financial orchestration. For this monetary application, such support is used to reinforce the monetary state governance layer and not to convert the claims into a general claim to every field or industry in the broader portfolio.

When a formal priority or domestic benefit relationship is desired for the ATMS/Banking/Finance/Settlement technical wall, the relationship should be accurately reflected in the official Application Data Sheet with the correct application number, filing date, relationship type, and continuity information.

The BEIMINT/Currency/TimeCurrency/Token technical wall may provide related support for minting, burning, time-denominated units, behavior-economic units, BEI Currency, tokenized value units, and ledger minting. For this monetary application, such support is used to reinforce the monetary state governance layer and not to convert the claims into a general claim to every field or industry in the broader portfolio.

When a formal priority or domestic benefit relationship is desired for the BEIMINT/Currency/TimeCurrency/Token technical wall, the relationship should be accurately reflected in the official Application Data Sheet with the correct application number, filing date, relationship type, and continuity information.

The DID/Identity/Signature/Trust technical wall may provide related support for identity anchors, DID records, BEISIGN, signature records, authentication, trust receipts, and proof-gated access. For this monetary application, such support is used to reinforce the monetary state governance layer and not to convert the claims into a general claim to every field or industry in the broader portfolio.

When a formal priority or domestic benefit relationship is desired for the DID/Identity/Signature/Trust technical wall, the relationship should be accurately reflected in the official Application Data Sheet with the correct application number, filing date, relationship type, and continuity information.

The Domain/TLD/Namespace/Digital Land technical wall may provide related support for domain-name resources, subdomain routing, signed endpoint records, domain parcels, and namespace basepoints. For this monetary application, such support is used to reinforce the monetary state governance layer and not to convert the claims into a general claim to every field or industry in the broader portfolio.

When a formal priority or domestic benefit relationship is desired for the Domain/TLD/Namespace/Digital Land technical wall, the relationship should be accurately reflected in the official Application Data Sheet with the correct application number, filing date, relationship type, and continuity information.

The Security/FR2/Rollback/Risk Control technical wall may provide related support for freeze, clawback, bounded correction, rollback-safe recovery, risk scoring, anomaly detection, and audit logs. For this monetary application, such support is used to reinforce the monetary state governance layer and not to convert the claims into a general claim to every field or industry in the broader portfolio.

When a formal priority or domestic benefit relationship is desired for the Security/FR2/Rollback/Risk Control technical wall, the relationship should be accurately reflected in the official Application Data Sheet with the correct application number, filing date, relationship type, and continuity information.

The MasterRoot Universal Object Architecture technical wall may provide related support for identity, authority, time, policy, privacy, evidence, signature, receipt, synchronization, and root-object fields that can support the monetary specialization. For this monetary application, such support is used to reinforce the monetary state governance layer and not to convert the claims into a general claim to every field or industry in the broader portfolio.

When a formal priority or domestic benefit relationship is desired for the MasterRoot Universal Object Architecture technical wall, the relationship should be accurately reflected in the official Application Data Sheet with the correct application number, filing date, relationship type, and continuity information.

### Commercial Deployment and Licensing Embodiments

In a bank middleware module deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The bank middleware module deployment may improve transaction safety by forcing a monetary lifecycle request through authority resolution, rule-version pinning, prior-state digest verification, policy-container evaluation, lifecycle ledger writing, and receipt generation before value release or state publication.

In a wallet verification SDK deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The wallet verification SDK deployment may improve transaction safety by forcing a monetary lifecycle request through authority resolution, rule-version pinning, prior-state digest verification, policy-container evaluation, lifecycle ledger writing, and receipt generation before value release or state publication.

In an exchange custody receipt service deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The exchange custody receipt service deployment may improve transaction safety by forcing a monetary lifecycle request through authority resolution, rule-version pinning, prior-state digest verification, policy-container evaluation, lifecycle ledger writing, and receipt generation before value release or state publication.

In a stable-value audit and reserve receipt portal deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The stable-value audit and reserve receipt portal deployment may improve transaction safety by forcing a monetary lifecycle request through authority resolution, rule-version pinning, prior-state digest verification, policy-container evaluation, lifecycle ledger writing, and receipt generation before value release or state publication.

In a CBDC gateway interoperability adapter deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The CBDC gateway interoperability adapter deployment may improve transaction safety by forcing a monetary lifecycle request through authority resolution, rule-version pinning, prior-state digest verification, policy-container evaluation, lifecycle ledger writing, and receipt generation before value release or state publication.

In a tokenized-deposit lifecycle controller deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The tokenized-deposit lifecycle controller deployment may improve transaction safety by forcing a monetary lifecycle request through authority resolution, rule-version pinning, prior-state digest verification, policy-container evaluation, lifecycle ledger writing, and receipt generation before value release or state publication.

In a verified-deposit pre-clearing API deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The verified-deposit pre-clearing API deployment may improve transaction safety by forcing a monetary lifecycle request through authority resolution, rule-version pinning, prior-state digest verification, policy-container evaluation, lifecycle ledger writing, and receipt generation before value release or state publication.

In an enterprise treasury state verification module deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The enterprise treasury state verification module deployment may improve transaction safety by forcing a monetary lifecycle request through authority resolution, rule-version pinning, prior-state digest verification, policy-container evaluation, lifecycle ledger writing, and receipt generation before value release or state publication.

In a government benefit disbursement verification service deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The government benefit disbursement verification service deployment may improve transaction safety by forcing a monetary lifecycle request through authority resolution, rule-version pinning, prior-state digest verification, policy-container evaluation, lifecycle ledger writing, and receipt generation before value release or state publication.

In a merchant settlement receipt verifier deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The merchant settlement receipt verifier deployment may improve transaction safety by forcing a monetary lifecycle request through authority resolution, rule-version pinning, prior-state digest verification, policy-container evaluation, lifecycle ledger writing, and receipt generation before value release or state publication.

In a auditor selective-disclosure console deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The auditor selective-disclosure console deployment may improve transaction safety by forcing a monetary lifecycle request through authority resolution, rule-version pinning, prior-state digest verification, policy-container evaluation, lifecycle ledger writing, and receipt generation before value release or state publication.

In a regulator digest publication node deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The regulator digest publication node deployment may improve transaction safety by forcing a monetary lifecycle request through authority resolution, rule-version pinning, prior-state digest verification, policy-container evaluation, lifecycle ledger writing, and receipt generation before value release or state publication.

In a SovMonetary institutional infrastructure portal deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The SovMonetary institutional infrastructure portal deployment may improve transaction safety by forcing a monetary lifecycle request through authority resolution, rule-version pinning, prior-state digest verification, policy-container evaluation, lifecycle ledger writing, and receipt generation before value release or state publication.

In a MonetaryObject specification portal deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The MonetaryObject specification portal deployment may improve transaction safety by forcing a monetary lifecycle request through authority resolution, rule-version pinning, prior-state digest verification, policy-container evaluation, lifecycle ledger writing, and receipt generation before value release or state publication.

In a MonetaryStateObject developer documentation portal deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The MonetaryStateObject developer documentation portal deployment may improve transaction safety by forcing a monetary lifecycle request through authority resolution, rule-version pinning, prior-state digest verification, policy-container evaluation, lifecycle ledger writing, and receipt generation before value release or state publication.

In a MonetaryReceipt verification gateway deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The MonetaryReceipt verification gateway deployment may improve transaction safety by forcing a monetary lifecycle request through authority resolution, rule-version pinning, prior-state digest verification, policy-container evaluation, lifecycle ledger writing, and receipt generation before value release or state publication.

In a BEIMSO API and SDK service deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The BEIMSO API and SDK service deployment may improve transaction safety by forcing a monetary lifecycle request through authority resolution, rule-version pinning, prior-state digest verification, policy-container evaluation, lifecycle ledger writing, and receipt generation before value release or state publication.

In a ATMS clearing and settlement node deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The ATMS clearing and settlement node deployment may improve transaction safety by forcing a monetary lifecycle request through authority resolution, rule-version pinning, prior-state digest verification, policy-container evaluation, lifecycle ledger writing, and receipt generation before value release or state publication.

In a BEIMINT monetary-state minting module deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The BEIMINT monetary-state minting module deployment may improve transaction safety by forcing a monetary lifecycle request through authority resolution, rule-version pinning, prior-state digest verification, policy-container evaluation, lifecycle ledger writing, and receipt generation before value release or state publication.

In a TrustReceipt cross-receipt publication service deployment, the infrastructure may expose a subset of registry, state-object, rule-version, lifecycle-ledger, receipt, audit, and verification functions suitable for that deployment. The deployment may be licensed, assigned, embedded, white-labeled, or operated as a managed service without changing the claimed technical core.

The TrustReceipt cross-receipt publication service deployment may improve transaction safety by forcing a monetary lifecycle request through authority resolution, rule-version pinning, prior-state digest verification, policy-container evaluation, lifecycle ledger writing, and receipt generation before value release or state publication.

### Examiner-Focused Technical Distinctions

The infrastructure is not merely a financial agreement or business practice; it recites a specific data object, registry, rule-version engine, lifecycle ledger, and receipt generation architecture.

The infrastructure is not merely the use of a generic ledger; the lifecycle ledger records monetary lifecycle transitions bound to authority records, rule versions, prior-state digests, event digests, and receipts.

The infrastructure is not merely a generic token; the monetary state object carries authority, rule-version, policy-container, privacy-boundary, lifecycle, and digest fields that control permitted state transitions.

The infrastructure is not merely a digital signature; signature material is used in combination with authority scope, key history, rule-version pinning, lifecycle state, prior-state digest, and receipt verification.

The infrastructure is not merely a compliance checklist; policy-container evaluation determines whether a computer system permits or rejects a state transition and writes a corresponding lifecycle event and receipt.

The infrastructure is not merely a domain name; a trusted-root identifier, including a domain-rooted identifier in some embodiments, resolves authority records, endpoint records, key histories, and verification paths used by the monetary lifecycle controller.

The infrastructure is not merely a receipt in the ordinary commercial sense; a monetary receipt is a machine-verifiable artifact binding object state, rule version, authority, digest, and lifecycle result.

The infrastructure is not merely error correction; freeze, revocation, recovery, and replacement preserve the prior evidence chain and create linked receipts rather than deleting or overwriting history.

### Additional Monetary Use Cases

In a payroll disbursement use case, the infrastructure may determine whether a value release, hold, freeze, revocation, recovery, conversion, settlement, or publication event is permitted by the applicable monetary state object and rule-version record.

In a insurance claim payment use case, the infrastructure may determine whether a value release, hold, freeze, revocation, recovery, conversion, settlement, or publication event is permitted by the applicable monetary state object and rule-version record.

In a medical reimbursement use case, the infrastructure may determine whether a value release, hold, freeze, revocation, recovery, conversion, settlement, or publication event is permitted by the applicable monetary state object and rule-version record.

In a education grant payment use case, the infrastructure may determine whether a value release, hold, freeze, revocation, recovery, conversion, settlement, or publication event is permitted by the applicable monetary state object and rule-version record.

In a public benefit transfer use case, the infrastructure may determine whether a value release, hold, freeze, revocation, recovery, conversion, settlement, or publication event is permitted by the applicable monetary state object and rule-version record.

In a cross-border remittance use case, the infrastructure may determine whether a value release, hold, freeze, revocation, recovery, conversion, settlement, or publication event is permitted by the applicable monetary state object and rule-version record.

In a merchant chargeback review use case, the infrastructure may determine whether a value release, hold, freeze, revocation, recovery, conversion, settlement, or publication event is permitted by the applicable monetary state object and rule-version record.

In a escrow release use case, the infrastructure may determine whether a value release, hold, freeze, revocation, recovery, conversion, settlement, or publication event is permitted by the applicable monetary state object and rule-version record.

In a royalty distribution use case, the infrastructure may determine whether a value release, hold, freeze, revocation, recovery, conversion, settlement, or publication event is permitted by the applicable monetary state object and rule-version record.

In a patent licensing payment use case, the infrastructure may determine whether a value release, hold, freeze, revocation, recovery, conversion, settlement, or publication event is permitted by the applicable monetary state object and rule-version record.

In a carbon credit settlement use case, the infrastructure may determine whether a value release, hold, freeze, revocation, recovery, conversion, settlement, or publication event is permitted by the applicable monetary state object and rule-version record.

In a energy unit settlement use case, the infrastructure may determine whether a value release, hold, freeze, revocation, recovery, conversion, settlement, or publication event is permitted by the applicable monetary state object and rule-version record.

In a compute unit micropayment use case, the infrastructure may determine whether a value release, hold, freeze, revocation, recovery, conversion, settlement, or publication event is permitted by the applicable monetary state object and rule-version record.

In a machine-agent payment authorization use case, the infrastructure may determine whether a value release, hold, freeze, revocation, recovery, conversion, settlement, or publication event is permitted by the applicable monetary state object and rule-version record.

In an AI-agent service billing use case, the infrastructure may determine whether a value release, hold, freeze, revocation, recovery, conversion, settlement, or publication event is permitted by the applicable monetary state object and rule-version record.

In a family wallet control use case, the infrastructure may determine whether a value release, hold, freeze, revocation, recovery, conversion, settlement, or publication event is permitted by the applicable monetary state object and rule-version record.

In a guardian-approved youth payment use case, the infrastructure may determine whether a value release, hold, freeze, revocation, recovery, conversion, settlement, or publication event is permitted by the applicable monetary state object and rule-version record.

In a emergency relief disbursement use case, the infrastructure may determine whether a value release, hold, freeze, revocation, recovery, conversion, settlement, or publication event is permitted by the applicable monetary state object and rule-version record.

In a institutional reserve proof use case, the infrastructure may determine whether a value release, hold, freeze, revocation, recovery, conversion, settlement, or publication event is permitted by the applicable monetary state object and rule-version record.

In a stable-value redemption use case, the infrastructure may determine whether a value release, hold, freeze, revocation, recovery, conversion, settlement, or publication event is permitted by the applicable monetary state object and rule-version record.

In a tokenized real-world asset cashflow use case, the infrastructure may determine whether a value release, hold, freeze, revocation, recovery, conversion, settlement, or publication event is permitted by the applicable monetary state object and rule-version record.

In a marketplace dispute hold use case, the infrastructure may determine whether a value release, hold, freeze, revocation, recovery, conversion, settlement, or publication event is permitted by the applicable monetary state object and rule-version record.

In a intercompany settlement use case, the infrastructure may determine whether a value release, hold, freeze, revocation, recovery, conversion, settlement, or publication event is permitted by the applicable monetary state object and rule-version record.

In a supply-chain finance payment use case, the infrastructure may determine whether a value release, hold, freeze, revocation, recovery, conversion, settlement, or publication event is permitted by the applicable monetary state object and rule-version record.

In a government procurement disbursement use case, the infrastructure may determine whether a value release, hold, freeze, revocation, recovery, conversion, settlement, or publication event is permitted by the applicable monetary state object and rule-version record.

In a healthcare provider credential-linked payment use case, the infrastructure may determine whether a value release, hold, freeze, revocation, recovery, conversion, settlement, or publication event is permitted by the applicable monetary state object and rule-version record.

In a professional service milestone payment use case, the infrastructure may determine whether a value release, hold, freeze, revocation, recovery, conversion, settlement, or publication event is permitted by the applicable monetary state object and rule-version record.

In a subscription entitlement value release use case, the infrastructure may determine whether a value release, hold, freeze, revocation, recovery, conversion, settlement, or publication event is permitted by the applicable monetary state object and rule-version record.

In a loyalty or reward conversion use case, the infrastructure may determine whether a value release, hold, freeze, revocation, recovery, conversion, settlement, or publication event is permitted by the applicable monetary state object and rule-version record.

In a time-work credit conversion use case, the infrastructure may determine whether a value release, hold, freeze, revocation, recovery, conversion, settlement, or publication event is permitted by the applicable monetary state object and rule-version record.

### ADDITIONAL PROSECUTION-SAFE IMPLEMENTATION EXAMPLES

The Registry Node may be implemented as a separate microservice, module, smart-contract service, database procedure, secure enclave workflow, institutional middleware component, or combined software routine that validates root monetary identifiers, authority records, public-key histories, delegation scope, and authority expiry before a monetary transition enters the rule-version engine.

The Registry Node may communicate with the other nodes through signed messages, authenticated API calls, message queues, ledger transactions, encrypted references, or local procedure calls. The architectural separation is optional and does not limit an implementation to a microservice architecture.

The Policy Container Node may be implemented as a separate microservice, module, smart-contract service, database procedure, secure enclave workflow, institutional middleware component, or combined software routine that stores rule-versioned issuance, transfer, settlement, hold, freeze, recovery, conversion, disclosure, and audit predicates in a signed or digest-bound format.

The Policy Container Node may communicate with the other nodes through signed messages, authenticated API calls, message queues, ledger transactions, encrypted references, or local procedure calls. The architectural separation is optional and does not limit an implementation to a microservice architecture.

The Lifecycle Controller Node may be implemented as a separate microservice, module, smart-contract service, database procedure, secure enclave workflow, institutional middleware component, or combined software routine that compares requested state, current state, permitted next state, and authority scope before writing a ledger event.

The Lifecycle Controller Node may communicate with the other nodes through signed messages, authenticated API calls, message queues, ledger transactions, encrypted references, or local procedure calls. The architectural separation is optional and does not limit an implementation to a microservice architecture.

The Receipt Node may be implemented as a separate microservice, module, smart-contract service, database procedure, secure enclave workflow, institutional middleware component, or combined software routine that receives accepted lifecycle event data and outputs monetary receipts suitable for external verification, audit, dispute handling, and publication.

The Receipt Node may communicate with the other nodes through signed messages, authenticated API calls, message queues, ledger transactions, encrypted references, or local procedure calls. The architectural separation is optional and does not limit an implementation to a microservice architecture.

The Audit Router Node may be implemented as a separate microservice, module, smart-contract service, database procedure, secure enclave workflow, institutional middleware component, or combined software routine that translates internal evidence and lifecycle data into digest-only, selective-disclosure, or role-gated verification responses.

The Audit Router Node may communicate with the other nodes through signed messages, authenticated API calls, message queues, ledger transactions, encrypted references, or local procedure calls. The architectural separation is optional and does not limit an implementation to a microservice architecture.

The Recovery Node may be implemented as a separate microservice, module, smart-contract service, database procedure, secure enclave workflow, institutional middleware component, or combined software routine that creates revocation, recovery, and replacement receipts while preserving source object evidence and avoiding destructive overwriting.

The Recovery Node may communicate with the other nodes through signed messages, authenticated API calls, message queues, ledger transactions, encrypted references, or local procedure calls. The architectural separation is optional and does not limit an implementation to a microservice architecture.

The Conversion Node may be implemented as a separate microservice, module, smart-contract service, database procedure, secure enclave workflow, institutional middleware component, or combined software routine that maps source and destination monetary classes while preserving conversion rule versions, source object references, destination object references, and event digests.

The Conversion Node may communicate with the other nodes through signed messages, authenticated API calls, message queues, ledger transactions, encrypted references, or local procedure calls. The architectural separation is optional and does not limit an implementation to a microservice architecture.

The Publication Node may be implemented as a separate microservice, module, smart-contract service, database procedure, secure enclave workflow, institutional middleware component, or combined software routine that publishes revocation, recovery, policy-update, and verification receipt digests to a cross-domain registry or other trusted publication location.

The Publication Node may communicate with the other nodes through signed messages, authenticated API calls, message queues, ledger transactions, encrypted references, or local procedure calls. The architectural separation is optional and does not limit an implementation to a microservice architecture.

### ADDITIONAL CLAIM DIFFERENTIATION SUPPORT

Differentiation example 1: a conventional bank ledger may record a balance or debit-credit entry, but the disclosed infrastructure produces a machine-verifiable monetary state object linked to a trusted-root authority record, pinned rule-version identifier, lifecycle state, prior-state digest, event digest, privacy-boundary result, and monetary receipt. This combination supports external verification without forcing all participants onto a single ledger or database.

Differentiation example 2: a conventional token system may record token transfers on one chain, but the disclosed infrastructure normalizes heterogeneous monetary classes into a common lifecycle model and verifies permitted state transitions across bank ledgers, wallets, exchanges, stable-value instruments, CBDC gateways, enterprise ledgers, time-currency units, and behavior-currency units.

Differentiation example 3: a conventional digital signature proves that a message was signed, but the disclosed receipt binds signature or verification material to authority scope, key history, rule-version status, prior-state digest continuity, event digest status, privacy boundary, and permitted next state.

Differentiation example 4: a conventional compliance workflow may approve or reject a transaction, but the disclosed policy-container and rule-version engine determine whether the computer system writes an append-only lifecycle event, places the object in hold or review, blocks reuse, or generates a settlement, freeze, revocation, recovery, conversion, publication, or external-verification receipt.

Differentiation example 5: a conventional freeze or correction may overwrite, reverse, or obscure records, but the disclosed infrastructure performs non-destructive freeze, revocation, recovery, and replacement while preserving the prior evidence chain and linking source and replacement monetary state objects through recovery or replacement receipts.

Differentiation example 6: a conventional audit export may disclose excessive account information, but the disclosed audit router can return digest-only, encrypted-reference, selective-disclosure, zero-knowledge, or role-gated verification responses while preserving policy-defined privacy boundaries.

Differentiation example 7: a conventional namespace or domain record may only identify an endpoint, but the disclosed trusted-root identifier binds authority records, rule-version references, key-history records, verification endpoints, governance scope, policy containers, and lifecycle-control information used by the monetary lifecycle controller.

Differentiation example 8: a conventional reconciliation system may compare after-the-fact records, but the disclosed infrastructure performs authority resolution, rule-version pinning, predicate evaluation, prior-state digest verification, ledger-event writing, and receipt generation before downstream value release or state publication.

### ADDITIONAL ASSET-PACKAGE AND LICENSING SUPPORT

A field-of-use license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a field-of-use license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A bank middleware license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a bank middleware license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A wallet SDK license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a wallet SDK license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A exchange custody license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a exchange custody license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A auditor verification license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a auditor verification license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A regulator portal license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a regulator portal license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A stable-value issuer license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a stable-value issuer license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A tokenized-deposit platform license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a tokenized-deposit platform license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A CBDC gateway technology license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a CBDC gateway technology license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A enterprise treasury license may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a enterprise treasury license, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A managed verification service may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a managed verification service, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A open standard plus proprietary implementation may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a open standard plus proprietary implementation, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A white-label API service may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a white-label API service, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A domain-rooted node franchise may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a domain-rooted node franchise, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

A patent-asset package transfer may map the claimed technology to a commercial deployment by identifying which components are activated: monetary authority registry, monetary state object, rule-version engine, lifecycle ledger, monetary receipt generator, privacy-preserving audit router, and external verification endpoint.

For diligence and valuation of a patent-asset package transfer, the technical proof package may include claim charts, API schemas, receipt schemas, state-transition tables, verification examples, trusted-root and domain-rooted endpoint documentation, and a mapping to ATMS, BEIMINT, TimeCurrency, BEI Currency, TrustReceipt, PolicyContainer, or BEIMSO implementation layers.

1. A trusted-root identifier-based monetary state object lifecycle governance and cross-system verification infrastructure, comprising: one or more processors; one or more memories storing instructions executable by the one or more processors; a trusted-root identifier-based monetary authority registry configured to bind a root monetary identifier to a plurality of authority records including an issuer authority record, a governance authority record, a settlement authority record, a freeze authority record, a recovery authority record, a conversion authority record, an audit authority record, and a publication authority record, each authority record including at least an authority scope, a public-key or credential reference, a validity interval, and a rule-version reference; a rule-version engine configured to evaluate, before a monetary lifecycle transition is accepted, a plurality of monetary predicates including issuer authority, rule-version validity, source-state validity, prior-state digest continuity, policy-container eligibility, time-window validity, privacy-boundary status, ledger-state status, and external-verifier permission; an issuance and lifecycle controller configured to create or update a machine-verifiable monetary state object only when the rule-version engine returns an authorized lifecycle result; a lifecycle ledger configured to record append-only monetary transition events including issued, active, pending, settled, held, frozen, revoked, recovered, converted, expired, archived, or published lifecycle states; and a monetary receipt generator configured to generate a machine-verifiable monetary receipt binding at least the root monetary identifier, the monetary state object, the rule-version reference, a prior-state digest, an event digest, a lifecycle state result, and a receipt signature or verification material.

2. The infrastructure of claim 1, wherein the machine-verifiable monetary state object includes a monetary object identifier, monetary class, issuer reference, owner or custody reference, authority reference, rule-version reference, monetary amount or unit reference, reserve or provenance reference, lifecycle state, prior-state digest, event digest, ledger reference, policy-container reference, privacy-boundary reference, receipt reference, and permitted next-state list.

3. The infrastructure of claim 1, wherein the machine-verifiable monetary state object is configured to be verified by an external verifier across at least two heterogeneous monetary systems selected from a commercial-bank ledger, central-bank digital-currency gateway, stable-value instrument platform, tokenized-deposit system, verified-deposit system, digital wallet, exchange, payment processor, enterprise treasury ledger, time-currency system, behavior-currency system, or governmental benefit system.

4. The infrastructure of claim 1, wherein the rule-version engine performs rule-version pinning by binding a transition request to a specific rule-version identifier and rejecting the transition request when a stale, superseded, unapproved, jurisdictionally invalid, or revoked rule version is detected.

5. The infrastructure of claim 1, wherein the lifecycle ledger records, for each accepted monetary transition event, a prior-state digest, current-state digest, event digest, rule-version identifier, authority record identifier, timestamp or interval reference, policy result, privacy-boundary result, and receipt identifier.

6. The infrastructure of claim 1, wherein a freeze controller is configured to place the monetary state object in a frozen or held state without deleting a prior lifecycle chain and to generate a freeze receipt that identifies a freeze authority, freeze basis, freeze interval, affected monetary scope, and permitted review path.

7. The infrastructure of claim 1, wherein a revocation controller is configured to place the monetary state object in a revoked state and to generate a revocation receipt while preserving a prior-state digest chain and preventing reuse of the revoked monetary state object.

8. The infrastructure of claim 1, wherein a recovery controller is configured to generate a replacement monetary state object linked to a source monetary state object by a recovery receipt, wherein the replacement monetary state object preserves lifecycle evidence of the source monetary state object.

9. The infrastructure of claim 1, wherein a conversion controller is configured to convert the monetary state object between monetary classes, rails, units, domains, ledgers, or custody environments according to a conversion rule version while generating a conversion receipt that preserves a source object reference and a destination object reference.

10. The infrastructure of claim 1, wherein the monetary receipt generator generates at least one of an issuance receipt, activation receipt, transfer receipt, settlement receipt, hold receipt, freeze receipt, revocation receipt, recovery receipt, conversion receipt, audit receipt, publication receipt, governance-update receipt, reserve receipt, or external-verification receipt.

11. The infrastructure of claim 1, wherein the monetary receipt generator exposes a verification endpoint configured to return a verification response including a root monetary identifier, lifecycle state, rule-version status, prior-state digest status, event-digest status, authority status, policy result, privacy-boundary status, and permitted next state.

12. The infrastructure of claim 1, wherein the root monetary identifier or trusted-root identifier comprises at least one of a domain name, subdomain, DNS-linked identifier, decentralized name, decentralized identifier, uniform resource identifier, certificate namespace, public-key namespace, legal-entity identifier, institutional registry identifier, signed endpoint record, blockchain namespace, account-root identifier, government registry identifier, enterprise namespace, domain-rooted identifier, or hybrid namespace root, and wherein a domain-rooted implementation may bind a domain name or subdomain to an authority registry, rule-version registry, verification endpoint, or key-history record.

13. The infrastructure of claim 1, further comprising a privacy-preserving audit router configured to provide selective-disclosure proofs, zero-knowledge proofs, encrypted references, digest-only publication, role-gated verification, or policy-authorized disclosure while withholding underlying personal, financial, institutional, or protected data.

14. The infrastructure of claim 1, wherein the monetary state object is implemented as a specialized monetary object within a broader trusted-root or domain-rooted universal object architecture including identity references, authority references, time intervals, policy containers, privacy boundaries, evidence digests, signature states, receipt references, and synchronization states.

15. The infrastructure of claim 1, wherein the rule-version engine is configured to determine a conflict condition selected from duplicate object identifier, duplicate value interval, invalid authority scope, reused proof reference, stale rule version, mismatched reserve reference, invalid prior-state digest, expired time window, privacy-boundary mismatch, ledger rollback condition, or unauthorized external-verifier request.

16. A computer-implemented method for trusted-root identifier-based monetary state object lifecycle governance and cross-system verification, comprising: receiving, by one or more processors, a monetary lifecycle request associated with a root monetary identifier; resolving a monetary authority record from a trusted-root identifier-based monetary authority registry; normalizing request data into a machine-verifiable monetary state object; pinning the request data to a rule-version identifier; validating issuer authority, source state, policy eligibility, time-window validity, privacy-boundary status, ledger status, and prior-state digest continuity;
generating a lifecycle result selected from permit, block, hold, freeze, settle, revoke, recover, convert, archive, publish, or review; recording an append-only monetary transition event in a lifecycle ledger; and generating a machine-verifiable monetary receipt binding the root monetary identifier, the monetary state object, the rule-version identifier, the lifecycle result, a prior-state digest, and an event digest.

17. The method of claim 16, wherein the lifecycle request comprises a tokenized-deposit, verified-deposit, commercial-bank deposit, stable-value instrument, central-bank digital-currency, digital wallet, exchange, time-currency, behavior-currency, enterprise treasury, or governmental benefit transition.

18. The method of claim 16, further comprising publishing a digest or receipt reference to a cross-domain registry while withholding underlying financial account data, personally identifiable information, protected data, or confidential institutional data unless a policy container authorizes disclosure.

19. The method of claim 16, further comprising receiving an external-verifier request from a bank, wallet, exchange, auditor, regulator, clearing system, merchant, enterprise system, or domain-rooted application and returning a verification response without requiring the external verifier to assume custody of the underlying monetary ledger.

20. One or more non-transitory computer-readable media storing instructions that, when executed by one or more processors, cause the one or more processors to perform operations comprising: maintaining a trusted-root identifier-based monetary authority registry; maintaining machine-verifiable monetary state objects; evaluating rule-version-pinned lifecycle predicates; writing append-only lifecycle transition events to a lifecycle ledger; generating monetary receipts for accepted lifecycle transitions; providing external verification of receipt and state information; and preserving privacy boundaries during cross-system monetary verification.
